(19) United States
(12) Patent Application Publication
(10) Pub. No.: US 2020/0026882 A1
(43) Pub. Date: Jan. 23, 2020

(54) METHODS AND SYSTEMS FOR ACTIVATING MEASUREMENT BASED ON A TRUSTED CARD

(71) Applicant: Alibaba Group Holding Limited, Grand Cayman (KY)

(72) Inventors: Yingfang Fu, Beijing (CN); Peng Xiao, Hangzhou (CN)

(21) Appl. No.: 16/460,907

(22) Filed: Jul. 2, 2019

(30) Foreign Application Priority Data
Jul. 19, 2018 (CN) 201810798739.X

(51) Int. Cl. G06F 21/72; H04L 9/30; G06F 21/60; H04L 9/32; H04L 9/06; G06F 21/57; G06F 21/74

(52) U.S. Cl. CPC G06F 21/72; H04L 9/30; G06F 21/602; G06F 2221/034; H04L 9/0643; G06F 21/57; G06F 21/74; H04L 9/3236

(57) ABSTRACT

Methods and systems for activating measurement based on a trusted card are provided. The method includes loading, by a security chip, a trusted metric root for a metric object to a host processor, wherein the trusted metric root is an encrypted metric root; receiving, by the security chip, a processing result after the host processor performs asymmetric encryption and decryption processing on the trusted metric root, wherein the processing result includes metric object data encrypted by a public key; decrypting, by the security chip, the metric object data encrypted by the public key; and determining, by the security chip, integrity of the metric object by performing a comparison on decrypted metric object data.

### CROSS REFERENCE TO RELATED PATENT APPLICATIONS

The application claims priority to Chinese Patent Application No. 201810798739.X, filed on Jul. 19, 2018, entitled “Method and system for activating measurement based on a trusted card,” which is hereby incorporated by reference in its entirety.

### TECHNICAL FIELD

The present disclosure relates to a field of trusted computing, and in particular, relates to methods and systems for activating measurement based on a trusted card.

### BACKGROUND

At present, commonly used trusted security chips include TPM/TPCM (Trusted Platform Model/Trusted Platform Control Model), which refers to a security chip conforming to TPM/TPCM standard. TPM/TPCM standard is a national standard for secure encryption processors written by TCG (International Trusted Computing Group). TPM/TPCM standard protects an encryption key by integrating it into a device using a special microcontroller. The security chip is generally bound to a computing platform through physical means, which can effectively protect a PC and prevent unauthorized users from accessing it. A security chip that provides integrity and authenticity for evidence is often physically bound to a computing platform.

The trusted security chip can protect the integrity of a platform and a system by means of metrics. Specifically, at certain moments, an object is measured and certain information of the object (such as the Hash value of the file) is obtained. The certain information is compared with a pre-recorded standard value to determine if the integrity of the object is compromised. However, at present, when a trusted security chip uses a metric to protect the integrity of the platform and the system, there is still a problem that the measurement result is inaccurate.

There is still no effective solution to address the technical problem of the measurement inaccuracy in determining the integrity of the platform and the system using the current trusted security chips.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The embodiments of the present disclosure provide methods and systems for activating measurement based on a trusted card to at least address the technical problem existing in the current trusted security chip, i.e., the measurement inaccuracy in determining the integrity of the platform and the system.

According to an aspect of an embodiment of the present disclosure, a method for activating measurement based on a trusted card is provided. The method comprises: loading, by a security chip, a trusted metric root for a metric object to a host processor, wherein the trusted metric root is an encrypted metric root; receiving, by the security chip, a processing result after the host processor performs asymmetric encryption and decryption processing on the trusted metric root, wherein the processing result includes metric object data encrypted by a public key; decrypting, by the security chip, the metric object data encrypted by the public key; and determining, by the security chip, integrity of the metric object by performing a comparison on decrypted metric object data.

According to another aspect of the embodiments of the present disclosure, another method for activating measurement based on a trusted card is provided. The method comprises: receiving, by a host processor, a trusted metric root of a metric object loaded by a security chip, wherein the trusted metric root is an encrypted metric root; performing, by the host processor, asymmetric decryption processing on the trusted metric root to obtain a processing result, where the processing result includes metric object data encrypted by a public key; and transmitting, by the host processor, the processing result to the security chip to determine integrity of the metric object by performing a comparison on decrypted metric object data to a metric reference value.

According to another aspect of the embodiments of the present disclosure, a system for activating measurement based on a trusted card is provided. The system comprises: a security chip configured to store a trusted metric root of a metric object, wherein the trusted metric root is an encrypted metric root; and a host processor configured to receive the trusted metric root of the metric object loaded by the security chip; and perform an asymmetric encryption and decryption process on the trusted metric root to obtain a processing result, wherein the processing result includes metric object data encrypted by a public key, wherein the security chip is further configured to decrypt the metric object data encrypted by the public key; and determine integrity of the metric object by performing a comparison on decrypted metric object data.

According to another aspect of an embodiment of the present disclosure, a storage medium including a stored program is provided, wherein when the stored program is executed, the device where the storage medium is located is controlled to perform the following steps: loading, by a security chip, a trusted metric root for a metric object to a host processor, wherein the trusted metric root is an encrypted metric root; receiving, by the security chip, a processing result after the host processor performs asymmetric encryption and decryption processing on the trusted metric root, wherein the processing result includes metric object data encrypted by a public key; decrypting, by the security chip, the metric object data encrypted by the public key; decrypting; and determining, by the security chip, integrity of the metric object by performing a comparison on decrypted metric object data.

According to another aspect of an embodiment of the present disclosure, a processor configured to execute a program is provided, wherein the program is executed causing the processor to perform the following steps: loading, by a security chip, a trusted metric root for a metric object to a host processor, wherein the trusted metric root is an encrypted metric root; receiving, by the security chip, a processing result after the host processor performs asymmetric encryption and decryption processing on the trusted metric root, wherein the processing result includes metric object data encrypted by a public key; decrypting, by the security chip, the metric object data encrypted by the public key; and determining, by the security chip, integrity of the metric object by performing a comparison on decrypted metric object data.

In the above exemplary embodiment of the present disclosure, the security chip may store a trusted metric root of the metric object, where the trusted metric root is an encrypted metric root. The host processor may receive the trusted metric root of the metric object loaded by the security chip. The trusted metric root may perform asymmetric encryption and decryption processing to obtain the processing result. The processing result may include the metric object data encrypted by a public key. The security chip may decrypt the metric object data encrypted by the public key and perform a comparison on decrypted metric object data to determine the integrity of the metric object. Since the metric root loaded by the security chip to the host processor is the encrypted metric root, the security of the metric root can be guaranteed, and the metric root may be prevented from being tampered with by the attack. The metric object data sent by the host processor to the security chip is also encrypted, which can also ensure the security of the metric object data, thereby ensuring the metric codes in the metric root and the accuracy of the result by executing the metric codes. Thus, the present disclosure solves the technical problem of the measurement inaccuracy in determining the integrity of the platform and the system using the current trusted security chips.

### BRIEF DESCRIPTION OF THE DRAWINGS

Drawings incorporated in the specification and forming part of the specification, in conjunction with the specification, illustrate exemplary embodiments, features, and aspects of the present disclosure, and are used to explain the principles of the disclosure but not intended to be limiting.

FIG. 1 illustrates a hardware block diagram of a computer terminal (or a mobile device) to implement a method of activating measurement based on a trusted card according to an embodiment of the present disclosure;

FIG. 2 illustrates a schematic diagram of a key system of a trusted high-speed encryption card according to Embodiment 1 of the present disclosure;

FIG. 3 illustrates a flowchart of a method for activating measurement based on a trusted card according to Embodiment 1 of the present disclosure;

FIG. 4 illustrates a flowchart of a method for activating measurement based on a trusted card according to Embodiment 1 of the present disclosure;

FIG. 5 illustrates a flowchart of a method for activating measurement based on a trusted card according to Embodiment 2 of the present disclosure;

FIG. 6 illustrates a schematic diagram of a system for activating measurement based on a trusted card according to Embodiment 3 of the present disclosure;

FIG. 7 illustrates a schematic diagram of an apparatus of a method for activating measurement based on a trusted card according to Embodiment 4 of the present disclosure;

FIG. 8 illustrates a schematic diagram of an apparatus for activating measurement based on a trusted card according to Embodiment 5 of the present disclosure;

FIG. 9 illustrates a flowchart of a data processing method according to Embodiment 6 of the present disclosure;

FIG. 10 illustrates a schematic diagram of a data processing apparatus according to Embodiment 7 of the present disclosure;

FIG. 11 illustrates a flowchart of a data processing method according to Embodiment 8 of the present disclosure;

FIG. 12 illustrates a schematic diagram of a data processing apparatus according to Embodiment 9 of the present disclosure; and

FIG. 13 illustrates a structural block diagram of a computer terminal according to Embodiment 10 of the present disclosure.

### DETAILED DESCRIPTION

The technical solutions in the embodiments of the present invention are clearly and completely described in the following with reference to the accompanying drawings in the embodiments of the present disclosure. The embodiment as described herein forms only part of the present disclosure but not all the embodiments. All other embodiments obtained by those skilled in the art based on the embodiments of the present disclosure without creative efforts shall fall within the scope of the present invention.

It should be noted that the terms “first,” “second,” and the like in the specification and claims of the present disclosure and the above-mentioned drawings are used to distinguish similar objects and are not necessarily used to describe a specific order or sequence. It is to be understood that such terms as used may be interchangeable where appropriate, so that the embodiments of the present disclosure described herein can be implemented in a sequence other than those illustrated or described herein. Furthermore, the terms “including” and “having” as well as any of their deformations, are intended to cover non-exclusive inclusion. For example, a method, a system, or an apparatus including a series of steps or one or more modules, is not necessarily limited to include the steps or modules as explicitly listed but can also include other steps or modules that are not explicitly listed or inherent to such processes, methods, products or devices.

First, some of the nouns or terms that appear in the description of the embodiments of the present disclosure are applicable to the following explanations:

Trusted Computing: Trusted Computing is a trusted computing platform supported by hardware security modules in computing and communication systems to improve the overall security of the system.

Trusted Platform Module (TPM/TPCM): Trusted Platform Model/Trusted Platform Control Model, a national standard for secure cryptographic processors, written by TCG (Trusted Computing Group). Through specialized micro-control, the device encrypts the encryption key into the device for protection. The TPM security chip refers to a security chip that conforms to the TPM standard. It is generally bound to the computing platform through physical means. It can effectively protect the PC and prevent unauthorized users from accessing. It can be a security chip that provides integrity and authenticity for evidence, which is usually physically bound to the computing platform.

Metric: At some specific moment, an object is measured, some information of the object (such as the Hash value of the file) is obtained, and the value of the information is compared with a pre-recorded standard value to determine whether the integrity of the object is compromised.

### Embodiment 1

The present disclosure according to Embodiment 1 provides a method for activating measurement based on a trusted card. It should be noted that the steps illustrated in the flowcharts of the figures may be executable in a computer system comprising a set of computer executable instructions. The steps illustrated in the flowcharts, although are ordered as, may be performed in different orders other than the ones as illustrated and described herein.

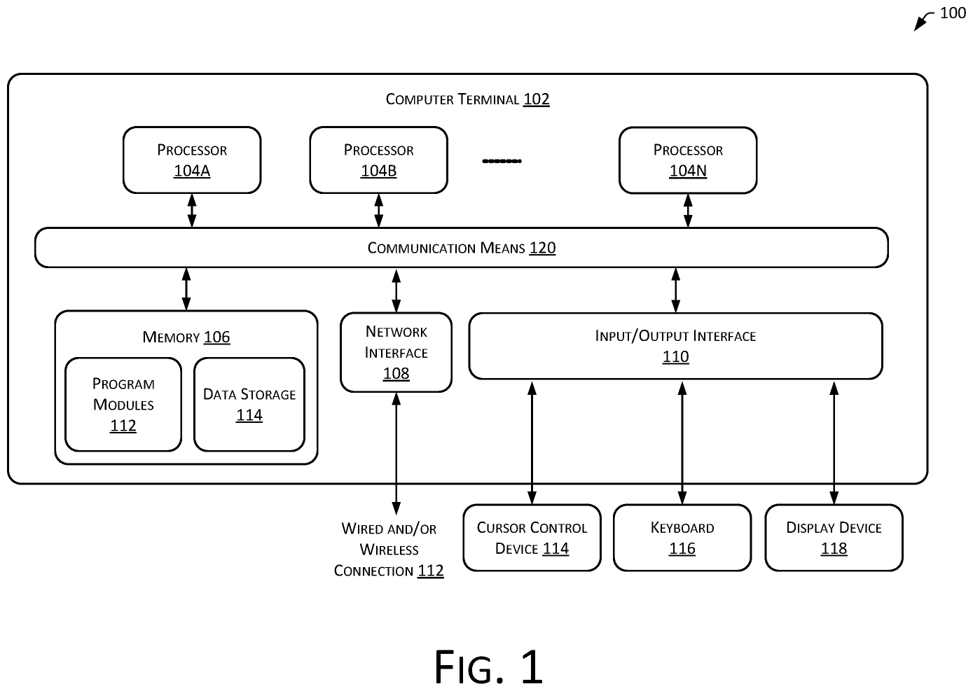

The method provided in Embodiment 1 of the present disclosure may be executed in a mobile terminal, a computer terminal or the like. FIG. 1 illustrates a hardware block diagram of a computer terminal (or a mobile device) to implement a method of activating measurement based on a trusted card. As shown in FIG. 1, a computer terminal 102 (or a mobile device 102) may include one or more processors 104A, 104B, . . . , 104N (that include but not limited to microprocessors (MCU), field programmable gate arrays (FPGAs), etc.), a memory 106 for storing data, and communication means 120. The computer terminal 102 may further include a display device 118, an input/output interface (I/O interface) 110, at least one universal serial bus (USB) port (that may be included as one of the I/O interface ports), a network interface 108, a power supply and/or camera. In embodiments, a cursor control device 114 and a keyboard 116 may be connected to the computer terminal 102 via the at least one USB port. The memory 106 may store one or more program modules 112 and a data storage 114. The network interface 108 may enable the data transmission between the computer terminal 102 and the network via a wired and/or wireless connection 112. It should be understood by those skilled in the art that the hardware block diagram of a computer terminal shown in FIG. 1 is merely for illustration purpose and it not intended to be limiting. For example, the computer terminal 102 may include more or fewer components than those as illustrated. As another example, the computer terminal 102 may be set in a different configuration from those as illustrated.

It should be noted that the one or more processors 104A, 104B, . . . , 104N and/or other data processing circuitry may be generally referred to as “data processing circuit” herein. The data processing circuit may be implemented as a whole or in part as software, hardware, firmware or any combination thereof. Further, the data processing circuit may be a single independent processing module or integrated as a whole or in part to any component of the computer terminal 102 (or a mobile device). As referred to in the embodiments of the present disclosure, the data processing circuit may be a control means of the processor (e.g., a selection of a terminal path for a variable resistance connected to an interface).

The memory 106 may be used to store software programs and program modules, for example, program instructions/data storage apparatus that correspond to a method of activating measurement based on a trusted card. The one or more processors 104A, 104B, . . . , 104N perform functional applications and data processing by executing the software programs and the corresponding program modules 112 stored in the memory 106, thus implementing the above-noted method of activating measurement based on a trusted card. The memory 106 may include high-speed random-access memory, non-volatile memory, such as one or more magnetic storage devices, flash memory, or other non-volatile solid-state memory. In embodiments, the memory 106 may be non-transitory. In some examples, the memory 106 may further comprise a remote memory configured for the one or more processors 104A, 104B, . . . , 104N. Such remote memory may be connected to the computer terminal 102 via a network. Examples of such networks may include but not limited to the Internet, intranets, local area networks, mobile communication networks, and any combinations thereof.

Communication means 120 are configured to transmit or receive data via a network. The communication means 120 may enable the data transmitting or receiving between the computer terminal 102 and the network through the network interface 108 via a wired and/or wireless connection 122. Examples of the above-described network may include a wireless communication network provided to the computer terminal 102 by a communication provider. In one embodiment, the communication means 120 may include a network adapter (Network Interface Controller, NIC), which can be connected to the Internet and communicate with other network devices via a base station. In one embodiment, the communication means 120 may be a radio frequency (RF) module for wireless communication via the Internet.

The display device 118 may include a touch panel liquid crystal display (LCD), which enables an interaction between a user and the computer terminal 102 via a user interface of the computer terminal 102 (or a mobile device).

It should be noted that in embodiments, the computer device (or the mobile device) shown in FIG. 1 may include hardware components (including circuits), software components (including computer codes stored on a computer readable medium), or a combination of both hardware and software components. It should be noted that FIG. 1 is merely one example of the embodiment and is intended to illustrate the types of components that may be present in the above-described computer device (or mobile device).

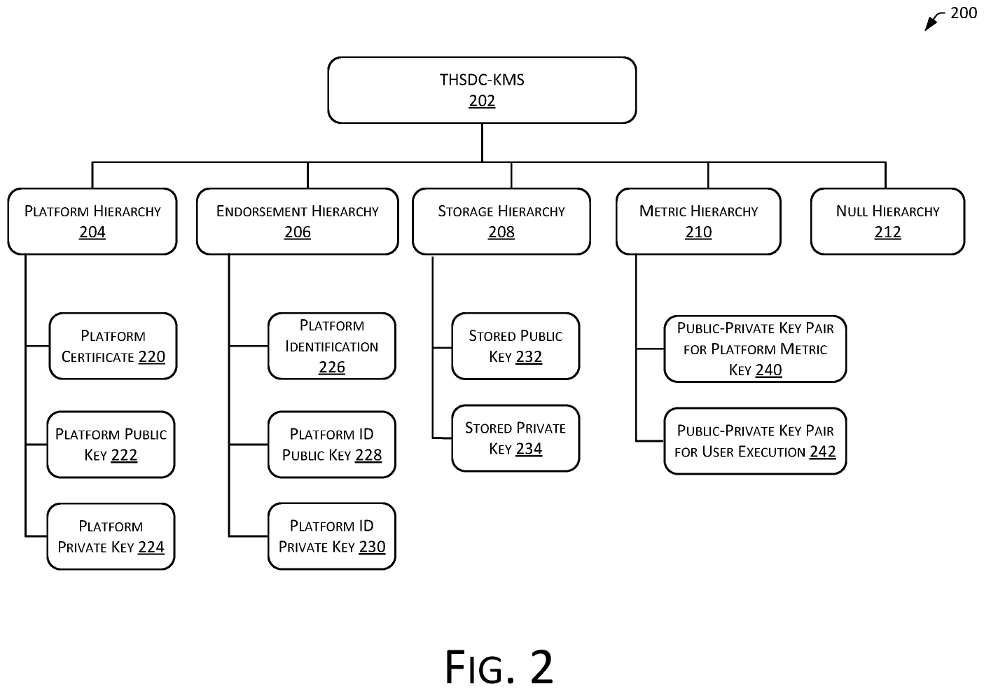

A security chip according to the present embodiment may be a THSDC chip. The key system of the THSDC chip uses four persistent key hierarchical structures to support different embodiments. FIG. 2 illustrates a schematic diagram of a key system of a trusted high-speed encryption card according to Embodiment 1 of the present disclosure. As shown in FIG. 2, the THSDC-KMS 202 (the Key Management System of THSDC) of the THSDC chip comprises a platform key hierarchical structure (platform hierarchy 204), a storage key hierarchical structure (storage hierarchy 208), an endorsement key hierarchical structure (endorsement hierarchy 206), and a metric key hierarchical structure (metric hierarchy 210). Each of the four key hierarchical structures has independent access authorization controls (authorization passwords and policies), separate administrators, and slightly different operation. The THSDC-KMS 202 of the THSDC chip may further include a null hierarchy 212 (null layer) different from the persistent key hierarchical structures, where an authorization key and the policy are both empty and are emptied after reboot. The handle structure that controls the access to the persistent key hierarchical structures are described herein below:

(1) platform key hierarchical structure (platform hierarchy 204) handle TPM_RH_Platform, which is generally used for distribution to platform OEMs. It is normally allocated by the BIOS and not visible upwards. The platform key hierarchical structure may include a platform certificate 220, a platform public-private key pair (222, 224). One platform has a unique platform public-private pair. The platform certificate may include information related to TPM/TPCM attributes, such as, TPM_id∥HSDEC_id, TPM-HSDEC_Public-key, etc., and the format of the platform certificate conforms to the X.509 certificate standard.

(2) storage key hierarchical structure (storage hierarchy 208) handle TPM_RH_OWNER, in which, the authorization key, i.e., owner password, is provided to the platform owner, for example, an IT operation and maintenance department or a service party. The platform of the service party may belong to storage key hierarchical structure. Different service parties may create a different primary SRK (storage root key, also known as primary storage key) under the storage key hierarchical structure, that is used to generate a key to protect the service, i.e., the key used to encrypt the service data. The storage key hierarchical structure (storage hierarchy 208) may include stored public key 232 and stored private key 234.

(3) endorsement key hierarchical structure (endorsement hierarchy 206) handle TPM_RH_ENDORSEMENT, in which, an endorsement key is mainly used for platform authentication. The endorsement key hierarchical structure may include a platform identity certificate 226, a platform identity public-private pair (228, 230). A platform may have multiple platform identity public-private pairs.

(4) metric key hierarchical structure (metric hierarchy 210) comprising a public-private key pair of a platform metric key 240, and a public-private key pair for user execution 242. The public-private key pair of a platform metric key 240 is used to determine the integrity of a platform and a system. The public-private key pair for user execution 242 is used to authenticate the integrity of the firmware associated with the loaded cryptographic operation during the user cryptographic operation.

Considering the privacy of the platform, a priority trusted card may have a platform layer metric root key, which can be stored in the trusted card by the manufacturer when leaving the factory. Considering the compatibility with the TCG standard instead of the platform privacy, the functionality of the platform layer metric root key in the metric measurement that is started during booting can also be replaced by the vendor's EK public-private key pair.

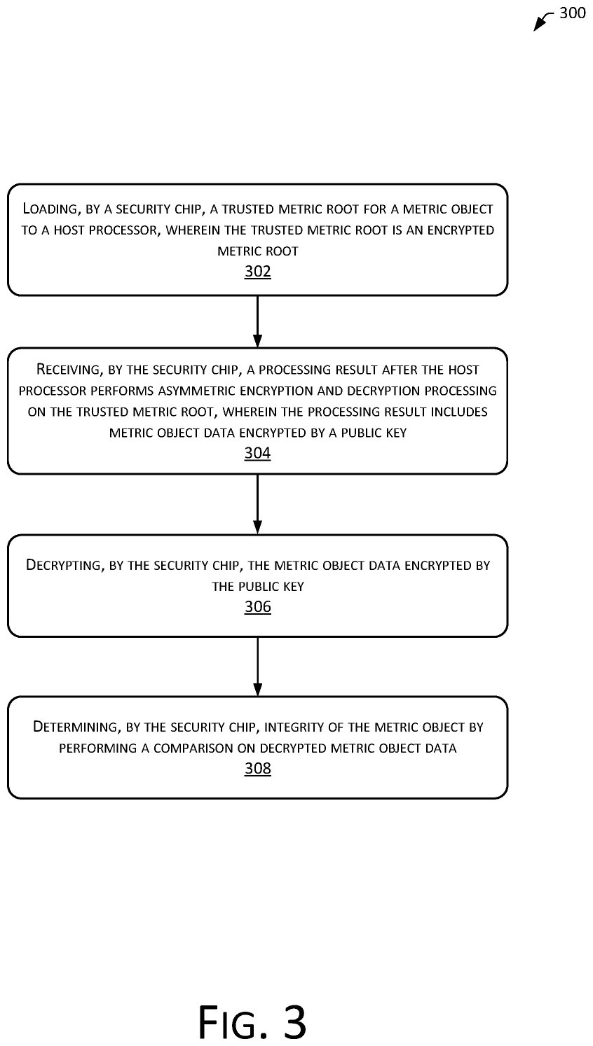

Under the above operating environment, the present disclosure provides a flowchart of a method for activating measurement based on a trusted card, as illustrated in FIG. 3. The flowchart of a method for activating measurement based on a trusted card is according to Embodiment 1 of the present disclosure. The method may include steps as follows:

In step 302, a security chip loads a trusted metric root for a metric object to a host processor, wherein the trusted metric root is an encrypted metric root.

In embodiments, the metric object may be a BIOS (Basic Input Output System), an OS Loader (Operating System Loader), an OS (Operating System) kernel, or the like.

The metric root may be reference value that is calculated during the first booting of the platform and the system. During the first booting, an initial metric value for the metric object is calculated. A Hash operation is further performed on the calculated initial metric value to obtain the reference value. During the booting other than the first booting, a metric value is calculated for the metric object and processed by a Hash operation. The Hash processed metric value is further compared with the reference value to determine whether to start the platform and the system. The above noted host processor may be the system CPU.

The metric root may be stored in the above-described security chip. The security chip may encrypt the metric root by a private key in a preset asymmetric key pair to obtain a trusted metric root. The trusted metric root is loaded into a memory of a main board, from where, the trusted metric root is further loaded to CPU.

In step 304, the security chip receives a processing result after the host processor performs asymmetric encryption and decryption processing on the trusted metric root, wherein the processing result includes metric object data encrypted by a public key.

In embodiments, the host processor may store the public key of the key pair, and the public key and the private key used to encrypt the metric root may form a pair of asymmetric keys.

In another embodiment, the host processor may perform asymmetric decryption processing on the trusted metric root to obtain a processing result. The host processor may perform decryption processing on the trusted metric root using the public key to obtain the metric root. The metric root may include metric codes. Metric object data may be obtained by executing the metric codes. The metric object data may be further encrypted using the public key to obtain the processing result.

The host processor may send the processing result to the security chip, and the security chip then receives the processing result after the host processor performs asymmetric encryption and decryption processing on the trusted metric root.

In the above steps, the processing result sent by the host processor to the security chip is the encrypted metric object data. Therefore, even if the metric object data is attacked during the transmitting from the host processor to the security chip, it is difficult for the attacker to obtain the metric object data and even more difficult to tamper with the metric object data.

In step 306, the security chip decrypts the metric object data encrypted by the public key.

In the above step 306, the security chip decrypts the metric object data encrypted by the public key to obtain metric object data.

In one embodiment, the secure chip may use the private key (i.e., the private key used to encrypt the metric root) to decrypt the metric object data encrypted by the public key to obtain metric object data.

In step 308, the security chip determines integrity of the metric object by performing a comparison on decrypted metric object data.

In one embodiment, the comparison may be performed between a Hash value of the decrypted metric object data and a metric reference value. If the Hash value of the decrypted metric object data equals to the metric reference value, it is determined that the metric object is in integrity. If the Hash value of the decrypted metric object data does not equal to the metric reference value, it is determined that the metric object is not in integrity. It is further determined that the platform and the system may be under attack and compromised. When the system needs to start in trust, if it is determined that the metric object is in integrity, the system can be started; and if it is determined that the metric object is not in integrity, the system is prohibited from starting or enters an unsafe start mode.

In one embodiment, the metric reference value for comparing the decrypted metric object data may be a Hash value calculated on the metric object data by performing a Hash operation when the system is first started. The metric reference value may be stored in the PCR of the security chip. Since the system is started for the first time, the hash value is trusted and can be used as a metric reference value for verifying the non-first-initiated metric object data. As the Hash value is calculated when the system is first started, the Hash value is trustable and can be used as a metric reference value to authenticate the metric object data obtained during the non-first starting of the system.

In the above embodiments of the present disclosure, the security chip may load the trusted metric root of the metric object to the host processor, where the trusted metric root is the encrypted metric root. The security chip may receive from the host processor a processing result after the host processor performs asymmetric encryption and decryption processing on the trusted metric root, wherein the processing result includes metric object data encrypted by a public key. The security chip may decrypt the metric object data and determine integrity of the metric object by performing a comparison on the decrypted metric object data encrypted by the public key. Since the metric root loaded by the security chip to the host processor is the encrypted metric root, the security of the metric root can be guaranteed, and the metric root is prevented from being tampered with. As the metric object data sent by the host processor to the security chip is also encrypted, the security of the metric object data is thus ensured, and further, the accuracy of the metric code in the metric root and the execution result of the metric code are also ensured.

Therefore, the foregoing embodiment of the present disclosure solves the technical problem of the measurement inaccuracy in determining the integrity of the platform and the system using the current trusted security chips.

In embodiments, the security chip may store the private key for the trusted metric root and the host processor may store the public key for the trusted metric root.

Specifically, the private key and the public key may form a pair of asymmetric keys. In one embodiment, the security chip manufacturer or the user of the security chip may put the public key PK (RPM) in the asymmetric key of the metric root on the CPU white list of the host before the security chip is used and the private key SK (RPM) in the asymmetric key in the security chip. The above solution can be implemented by using the intel SGX technology, thereby achieving the integration of the TPM and the SGX technology.

In another embodiment, before the security chip loads the trusted metric root of the metric object to the host processor, the above method may further include powering on the security chip, loading, by the security chip, a metric root of the metric object to the encryption module of the security chip, and encrypting the metric root, by the encryption module, using the private key to obtain the trusted metric root.

Specifically, the foregoing encryption module may be an encryption module that performs an encryption operation in the security chip, and the security chip loads the metric root to the encryption module to generate the encrypted trusted metric root.

The metric root may be stored in the security chip. In another embodiment, after the security chip is powered on, the security chip may use the private key of the platform metric root (i.e., the private key) to encrypt the metric root to obtain the trusted metric root. The trusted metric root may be further loaded by the security chip to the host processor.

In the above embodiment, the metric root may be encrypted by the encryption module to obtain the trusted metric root after the security chip is powered on. In another embodiment, the metric root may be encrypted using the private key of the platform root key pair and stored in the security chip before the security chip leaves the factory so as to protect the safety of the metric root in the security chip.

In another embodiment, after the security chip loads the trusted root metric of a metric object to the host processor, the method may further include decrypting, by the host processor, the trusted metric root using the public key to obtain a decrypted trusted metric root, executing, by the host processor, the decrypted trusted metric root to obtain the metric object data, encrypting, by the host processor, the metric object data using the public key, and sending, by the host processor, the encrypted metric object data to the security chip.

Specifically, the above noted private key and public key may form a pair of asymmetric keys. The host processor may decrypt the trusted metric root using the stored public key to obtain the metric root. The metric root may include metric codes, which when executed by the host processor, may generate the metric object data. The host processor may further encrypt the metric object data using the public key such that when the security chip receives the encrypted metric object data, the security chip may use the private key to decrypt the encrypted metric object data to obtain the metric object data.

As described in the above embodiments, the public key may be stored in the host processor, and the private key may be stored in the security chip. When the host processor obtains the metric root, the security chip may load the trusted metric root, i.e., encrypted metric root to the host processor. When the host processor sends the metric object data to the security chip, the host processor may also encrypt the metric object data and further send the encrypted metric object data to the security chip. Therefore, when the host processor is under attack, the attacker cannot tamper with the metric root and the metric object data. Thus, the host processor is ensured to be loaded with the correct metric root and the security chip is also ensured to receive the correct process result based on the correct metric root.

In another embodiment, the security chip may decrypt the encrypted metric object data, which includes calling, by the security chip, a decryption module, and decrypting, by the decryption module, the metric object data encrypted by the public key by using the private key to obtain the decrypted metric object data.

Specifically, the foregoing decryption module may decrypt the encrypted metric object data using the private key stored in the security chip to obtain the metric object data.

In another embodiment, the security chip may perform a comparison on the decrypted metric object data to determine the integrity of the metric object, which includes calculating, by the security chip, a Hash value of the metric object data, comparing the calculated Hash value with a metric reference value, and determining that the integrity of the metric object is in a normal state in response to a comparison result satisfying a predetermined condition.

Specifically, the security chip may determine the Hash value of the metric object data using a Hash operation. The stored metric reference value may be a Hash value obtained by the security chip performing a Hash operation on the metric object data when the platform and the system are first started. The Hash value may be stored in the security chip after the first boot. The foregoing predetermined condition may be that the calculated Hash value equals to the stored metric reference value.

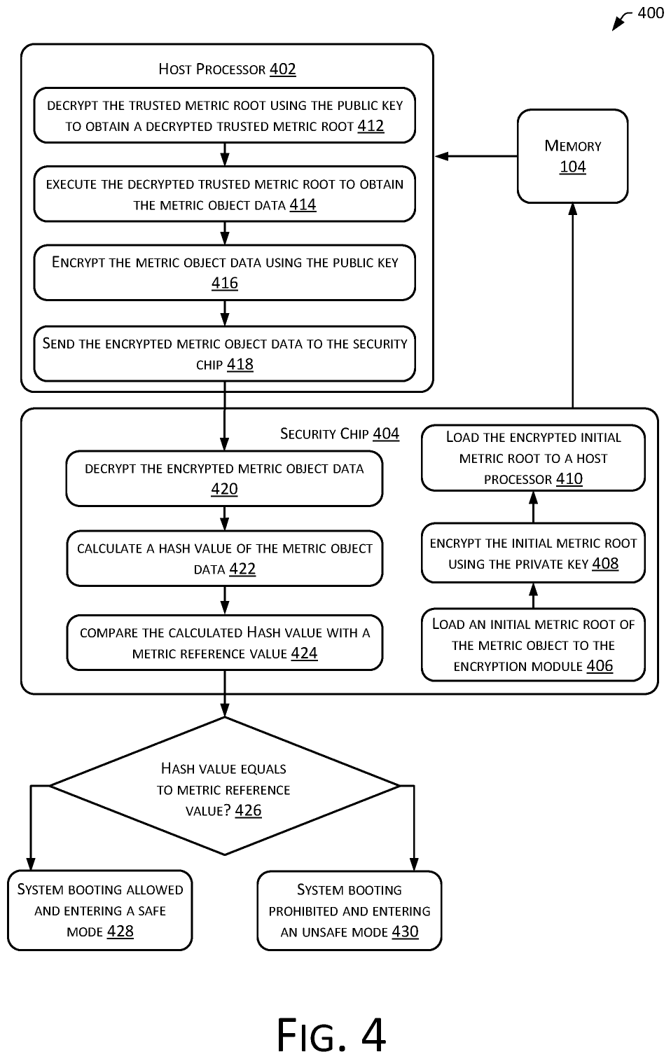

In embodiments, as illustrated in FIG. 4, the security chip 404 may compare the Hash value of the metric object (i.e., the Hash value of the metric object data) to the stored PCR value (i.e., the metric reference value stored in PCR), and if the Hash value of the metric object equals to the stored PCR, the security chip 404 may determine that the metric object is in a normal state.

In another embodiment, before the security chip loads the trusted metric root of the metric object to the host processor, the method may further include upon first booting, loading, by the security chip, an initial trusted metric root of the metric object to the host processor, wherein the initial trusted metric root is an encrypted initial metric root, receiving, by the security chip, an initial processing result after the host processor performs asymmetric encryption and decryption processing on the initial trusted metric root, where the initial processing result includes initial metric object data encrypted by the public key, calculating, by the security chip, an initial hash value of the initial metric object data; determining, by the security chip, the initial hash as the metric reference value, and storing the metric reference value to the security chip.

As described in the above embodiment, the security chip may obtain the metric reference value when the platform and the system first start. As the integrity of the platform and the system is determined to be in normal state, the obtained metric reference value may be the foregoing metric reference value stored in the security chip, which is used to compare with the Hash value of the metric object data during the non-first booting.

In embodiments, when the platform and the system first start, the security chip may encrypt the metric root using a private key through an encryption module to obtain the trusted metric root. The security chip may further load the trusted metric root to the memory of the host, which is further loaded from the memory to the host processor. The host processor may decrypt using the public key to obtain the metric root, executing the metric codes in the metric root to obtain the metric object data. The host processor may further encrypt the metric object data using the public key and send the encrypted metric object data to the security chip.

The security chip may decrypt the received the metric object data encrypted by the public key using a private key to obtain the metric object data, calculate a Hash value of the metric object data, and store the Hash value in the PCR as the reference metric value.

In embodiments, the metric object may include a plurality of metric objects, and the method may further comprise determining, by the security chip, integrity of each of the plurality of metric objects, determining, by the security chip, whether the integrity of each of the plurality of metric objects is in a normal state, and in response to a determination that the integrity of each of the plurality of metric objects is in a normal state, determining that integrity of a platform and a system in which the security chip is implemented is not compromised, and the system enters a safe mode.

Specifically, the foregoing safe mode may indicate that the executing environment of the platform and the system is safe, and the platform and the system may start normally. The integrity of the metric object being in a normal state may indicate that the Hash value of the metric object data equals to the stored PCR value, i.e., the metric reference value.

In embodiments, the metric object of the platform may include a BIOS, an OS Loader, and an OS kernel. According to the integrity measurement method of the present embodiment, the integrity of the BIOS, the OS Loader, and the OS kernel may be all determined. When the integrity of all of the BIOS, the OS Loader, and the OS kernel are in normal state, it may be determined that the integrity of the platform and the system are in normal state and the system can enter a safe mode.

In another embodiment, in response to a determination that the integrity of one or more of the plurality of metric objects is in an abnormal state, the integrity of the platform and the system in which the security chip is implemented may be determined to be compromised, and the system enters an unsafe mode, or the system is prohibited from booting.

In the above embodiment, if any one of the one or more of the plurality of metric objects is not in integrity, it may be determined that the platform or the system may be attacked. Therefore, the system and the platform may be prohibited from starting or enter an unsafe mode.

FIG. 4 illustrates a flowchart of a method for activating measurement based on a trusted card according to Embodiment 1 of the present disclosure. The trusted card may be the foregoing security chip. The method for activating measurement based on a trusted card is described herein in conjunction with the FIG. 4.

This embodiment performs the above method on the basis of two assumptions. In assume condition 1, a trusted card vendor or trusted card consumer has stored the public key SK of the platform metric root key (RPM) on the host's CPU white list and the private key SK (RPM) in the trusted card. In assumption condition 2, the trusted card has completed first booting of the system, i.e., the Hash value of the metric object data has been stored in PCR of the trusted card. The method may include steps as follows:

At step 406, when the security card 404 is powered on, the security card may load an initial metric root to an encryption module.

At step 408, the encryption module may execute the encrypting instructions and encrypt the initial metric root using a private key of the platform root key.

Specifically, the platform root key may be a pair of asymmetric keys. At step 408, the encryption module may use a private key of the pair of asymmetric keys to encrypt the initial metric root.

At step 410, the security card 404 may load the encrypted metric root to the memory 104 of the host. The encrypted metric root may be further loaded from the memory 104 to the host processor 402.

At step 412, the host processor 402 may decrypt the trusted metric root using the public key to obtain a decrypted trusted metric root.

At step 414, the host processor 402 may execute the metric codes in the decrypted trusted metric root to obtain the metric object data.

At step 416, the host processor 402 may encrypt the metric object data using the public key.

At step 418, the host processor 402 may send the encrypted metric object data to the security chip 404.

At step 420, the security chip 404 may decrypt the CPU encrypted metric object data by calling a decryption module.

At step 422, the security chip 404 may calculate a Hash value of the metric object data.

At step 424, the security chip 404 may compare the calculated Hash value with a stored PCR value, i.e., a metric reference value.

At step 426, the security chip 404 may determine whether the Hash value equals to metric reference value.

At step 428, the system booting is allowed, and the system enters a safe mode in response to a determination that the Hash value equals to metric reference value. That is, when the Hash value equals to metric reference value, the integrity of the metric object is determined to be not compromised. When the integrity of all metric objects is determined to be not compromise, it is determined that the platform and the system are not comprised and can start to enter safe mode.

At step 430, the system booting is prohibited, and the system enters an unsafe mode in response to a determination that the Hash value does not equal to metric reference value. That is, when the Hash value does not equal to metric reference value, the integrity of the metric object is determined to be compromised. When the integrity of any one of the metric objects is determined to compromise, it is determined that the platform and the system are compromised, and the system is prohibited from booting or the system enters an unsafe mode.

### Embodiment 2

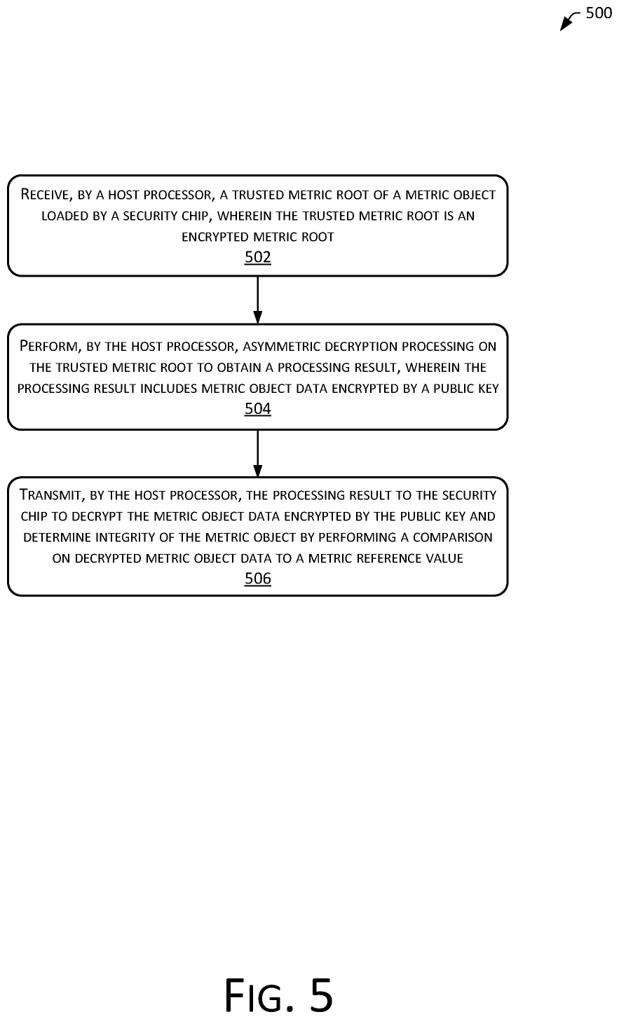

A method for starting a metric based on a trusted card according to an embodiment of the present invention is provided. FIG. 5 illustrates a flowchart of a method for activating measurement based on a trusted card according to Embodiment 2 of the present disclosure. The method may include steps as follows:

At step 502, the host processor may receive a trusted metric root of a metric object loaded by a security chip, wherein the trusted metric root is an encrypted metric root.

Specifically, the above described encrypted metric root may include metric codes used to compute metric object data. The metric root may be encrypted by the secure chip metric to obtain the trusted metric root, which may be further loaded to the secure chip.

In another embodiment, the security chip may encrypt the metric root by using a private key to obtain a trusted metric root, and then load the trusted metric root into a memory space on the main board. The trusted metric root may be loaded from the memory space to the host processor.

Since the metric root loaded by the security chip to the host processor is the trusted metric root, i.e., the encrypted metric root, even if the host processor is attacked, the metric root cannot be obtained or tampered with, thereby ensuring the credibility of subsequent calculations.

At step 504, the host processor may perform asymmetric decryption processing on the trusted metric root to obtain a processing result, where the processing result includes metric object data encrypted by a public key.

Specifically, the host processor may store the public key in a key pair, and the public key and the private key that encrypts the metric root may form a pair of asymmetric keys.

In another embodiment, the host processor may perform asymmetric encryption and decryption processing on the trusted metric root, and the host processor may decrypt the trusted metric root by using the public key to obtain a metric root. The metric root may include metric codes, and execution of the metric codes by the host processor may generate the metric object data of the metric object. The host processor may use the public key to encrypt the metric object data to obtain the processing result.

At step 506, the host processor may transmit the processing result to the security chip to decrypt the metric object data encrypted by the public key and determine integrity of the metric object by performing a comparison on decrypted metric object data to a metric reference value.

The host processor may send the obtained processing result to the security chip, and the security chip may receive the processing result after the host processor performs asymmetric encryption and decryption processing on the trusted metric root. The security chip may decrypt the processing result using the private key to obtain the metric object data.

The security chip may compute a Hash value of the metric object data and compare the Hash value with a stored reference metric value to determine integrity of the metric object.

In the above steps, the processing result sent by the host processor to the security chip may be encrypted metric object data, so that even if the metric object data is attacked during the transmission from the host processor to the security chip, it is difficult for the attacker to obtain the metric object data and even more difficult to tamper with the metric object data.

The host processor of the foregoing embodiment of the present disclosure may receive the trusted metric root of the metric object loaded by the security chip, where the trusted metric root may be an encrypted metric root. The host processor may perform asymmetric encryption and decryption processing on the trusted metric root to obtain a processing result, wherein the processing result may comprise a metric object data encrypted by a public key. The host processor may transmit the processing result to the security chip, where the security chip may decrypt the metric object data encrypted by the public key and perform a comparison on the decrypted metric object data to determine integrity of the metric object. Since the metric root loaded by the security chip to the host processor is an encrypted metric root, the security of the metric root can be guaranteed. The metric root may be prevented from being tampered with by the attack during the transmission of the metric object data from the host processor to the security chip. The encryption process can ensure the security of the metric object data, thereby ensuring the metric codes in the metric root and the accuracy of the result by executing the metric codes. Thus, the present disclosure solves the technical problem of the measurement inaccuracy in determining the integrity of the platform and the system using the current trusted security chips.

As another embodiment, the security chip may store the private key of the trusted root key, and the host processor may store the public key of the trusted root key.

Specifically, the private key and the public key may form a pair of asymmetric keys. In one embodiment, the security chip manufacturer or the user of the security chip can put the public key PK (RPM) in the pair of asymmetric keys of the metric root on the CPU white list of the host before the security chip is used, and the private key SK (RPM) in the pair of asymmetric keys is stored in the security chip. The above solution may be implemented by using the intel SGX technology, thereby achieving the integration of the TPM and the SGX technology.

It should be noted that the foregoing methods and embodiments are described as combinations of series of actions for the sake of simple description. However, it should be understood by those skilled in the art that the present disclosure is not limited by the described action sequence. Because certain steps may be performed in other sequences or concurrently in accordance with the present disclosure. In addition, it should be understood by those skilled in the art that the embodiments described in the specification are all preferred embodiments, and the actions and modules involved are not necessarily required by the present disclosure.

Through the description of the above embodiments, those skilled in the art can clearly understand that the method according to the above embodiment can be implemented by means of software with a necessary general hardware platform. In embodiments, the method according to the above embodiment can be implemented by hardware. But in many cases, implementation by means of software with a necessary general hardware platform may be preferred. Based on such understanding, the technical solution of the present disclosure, which is essential or contributes to the prior art, may be implemented in the form of a software product stored in a storage medium (such as ROM/RAM, disk, the optical disc) including a number of instructions for causing a terminal device (which may be a cell phone, a computer, a server, or a network device, etc.) to perform the methods described in various embodiments of the present disclosure.

### Embodiment 3

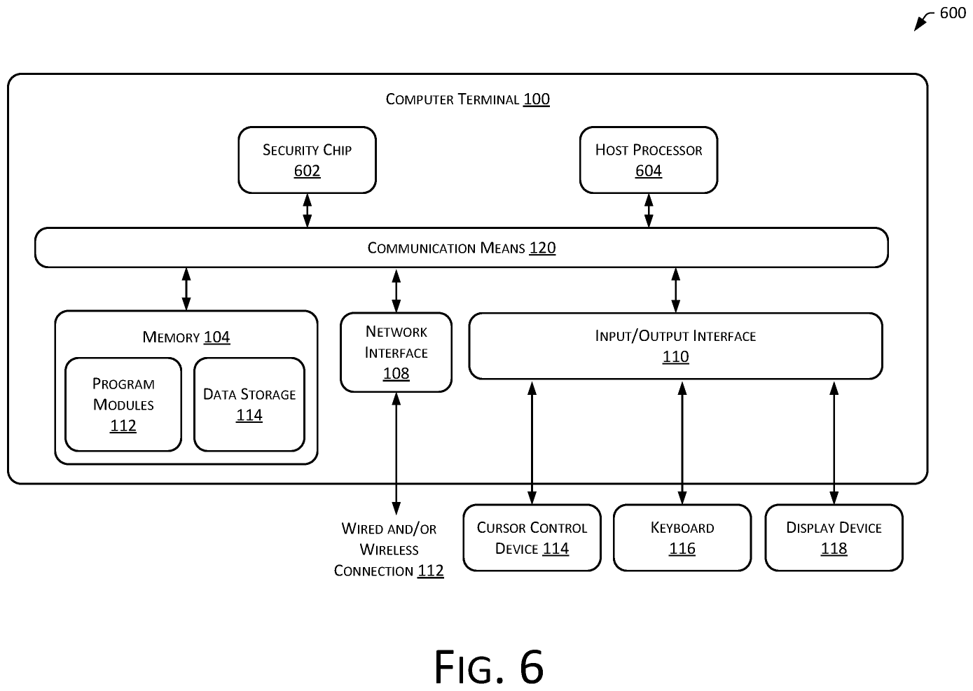

According to an embodiment of the present disclosure, a system that is started based on trusted card is provided. FIG. 6 illustrates a schematic diagram of a system for activating measurement based on a trusted card according to Embodiment 3 of the present disclosure.

The system 600 may be implemented on the computer terminal 100, as illustrated in FIG. 1. The system 600 include a security chip 602 configured to store a trusted metric root of a metric object, where the trusted metric root is an encrypted metric root.

Specifically, the metric object may be a BIOS, an OS Loader, an OS kernel, or the like. The metric root may be used to calculate the metric value of the metric object when the platform and the system are first started. The metric value may be a Hash value and stored as a reference metric value. When the platform and the system are not started for the first time, a metric value may be calculated, and a Hash value of the metric value may be compared with the reference metric value to determine whether to start the platform and the system. The above host processor may be the CPU of the system.

The metric root may be stored in the security chip. The security chip may encrypt the metric root by using a private key in a stored asymmetric key pair to obtain a trusted metric root, and then load the trusted metric root to the host processor.

In another embodiment, the metric root of the metric object may be stored within the security chip so that the security chip may directly encrypt the metric root to obtain a trusted metric root. The trusted metric root may be further loaded into a memory of a main board, and the trusted metric root may be further loaded into the CPU from memory.

The system 600 may further include a host processor 604 configured to receive a trusted metric root of a metric object loaded by a security chip and perform asymmetric decryption processing on the trusted metric root to obtain a processing result.

In one embodiment, the host processor may perform asymmetric encryption and decryption processing on the trusted metric root and decrypt the trusted metric root by using the public key to obtain a metric root. The metric root may include metric codes and execution of the metric code by the host processor may generate the metric object data of the metric object. The host processor may use the public key to encrypt the metric object data and obtain the processing result.

The security chip may decrypt the encrypted metric data using a private key (i.e., a private key that encrypts the metric root) to obtain metric object data. The security chip may compare a Hash value of the decrypted metric object data with the metric reference value. If the Hash value of the metric object data is the same as the metric reference value, it may be determined that the metric object is complete; and if the Hash value of the metric object data is different from the metric reference value, it may be determined that the metric object is incomplete, and the platform and the system may be compromised. When the user performs a trusted boot of the system, if it is determined that the metric object is complete, the system may be started; and if it is determined that the metric object is not complete, the system may be prohibited from starting or enter a non-secure startup mode.

Further, the security chip may also perform other steps in the Embodiment 1 of the present disclosure. The host processor may also perform other steps in the second embodiment of the present disclosure, and details are not described herein again.

In the above embodiment of the present disclosure, the security chip may store a trusted metric root of the metric object, where the trusted metric root is an encrypted metric root. The host processor may receive the trusted metric root of the metric object loaded by the security chip. The trusted metric root may perform asymmetric encryption and decryption processing to obtain the processing result. The processing result may include the metric object data encrypted by a public key. The security chip may decrypt the metric object data encrypted by a public key and perform a comparison on the decrypted metric object data to determine the integrity of the metric object. Since the metric root loaded by the security chip to the host processor is the encrypted metric root, the security of the metric root can be guaranteed, and the metric root may be prevented from being tampered with by the attack. The metric object data sent by the host processor to the security chip is also encrypted, which can also ensure the security of the metric object data, thereby further ensuring the metric codes in the metric root and the accuracy of the result by executing the metric codes in the metric root. Thus, the present disclosure solves the technical problem of the measurement inaccuracy in determining the integrity of the platform and the system using the current trusted security chips.

As another embodiment, the security chip may store the private key of the trusted root key, and the host processor may store the public key of the trusted root key.

Specifically, the private key and the public key may form a pair of asymmetric keys. In one embodiment, the security chip manufacturer or the user of the security chip can put the public key PK (RPM) in the pair of asymmetric keys of the metric root on the CPU white list of the host before the security chip is used, and the private key SK (RPM) in the pair of asymmetric keys is stored in the security chip. The above solution may be implemented by using the intel SGX technology, thereby achieving the integration of the TPM and the SGX technology.

The system may include one or more components that are similar to those illustrated in FIG. 1, and thus, are not described in detail herein.

### Embodiment 4

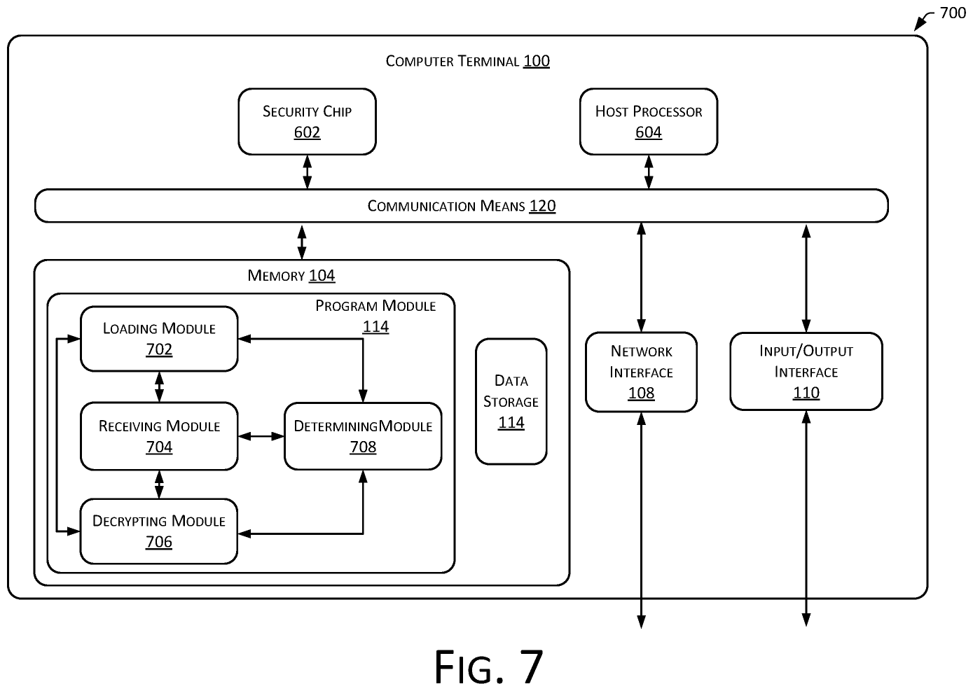

According to an embodiment of the present invention, an apparatus to implement a method for activating measurement based on the trusted card described in Embodiment 1 is provided. FIG. 7 illustrates a schematic diagram of an apparatus of a method for activating measurement based on a trusted card according to Embodiment 4 of the present disclosure.

The apparatus 700 may be implemented on a computer terminal 100, as illustrated in FIG. 1. The apparatus 700 may include a loading module 702 configured to load, by the security chip, a trusted metric root to a host processor, wherein the entrusted metric root is encrypted metric root.

The apparatus 700 may further include a receiving module 704 configured to receive, by the security chip, a processing result after the host processor performs asymmetric encryption and decryption processing on the trusted metric root, where the processing result includes metric object data encrypted by a public key.

The apparatus 700 may further include a decrypting module 706 configured to decrypt, by the security chip, the metric object data encrypted by the public key.

The apparatus 700 may further include a determining module 708 configured to determine, by the security chip, integrity of the metric object by performing a comparison on decrypted metric object data.

It should be noted here that the above loading module 702, the receiving module 704, the decrypting module 706 and the determining module 708 may correspond steps 302, 304, 306, and 308, respectively, as described in Embodiment 1. The embodiments and application environment of the foregoing four modules and four steps may be the same but not limited to the content disclosed in the Embodiment 1. It should be noted that the above modules may be operated as part of an apparatus implemented in the computer terminal 100 provided in Embodiment 1 and Embodiment 3.

In another embodiment, the security chip may store the private key of the trusted root key pair, and the host processor may store the public key of the trusted root key pair.

In another embodiment, the foregoing apparatus may further include a power-on module and an encryption module. The power-on module may be configured to power on the security chip before the security chip loads the metric root of a metric object to an encryption module and loads the trusted metric root of the metric object to the host processor. The encryption module may be configured to encrypt the metric root, by the security chip, using the private key to obtain a trusted metric root.

In another embodiment, the foregoing apparatus may further include a decrypting module, an execution module, and a transmission module. The decrypting module may be configured to decrypt the trusted metric root, by the host processor, using a public key after the security chip loads the trusted metric root of the metric object to the host processor to obtain decrypted trusted metric root. The execution module may be configured to execute, the host processor, the decrypted trusted metric root to obtain the metric object data. The transmission module may be configured to encrypt, by the host processor, the metric object data using the public key and transmit the encrypted metric object data to the security chip.

In another embodiment, the decrypting module may include a calling sub-module for the security chip to invoke the decrypting module and a decrypting sub-module for the security chip to decrypt the encrypted metric object data by using a private key to obtain the metric object data.

In another embodiment, the determining module may include a calculating sub-module configured to calculate, by the security chip, a Hash value of the metric object data, a comparison sub-module configured to compare, by the security chip, the Hash value with a stored metric reference value, and a determining sub-module for determining that the integrity of the metric object is in a normal state if the comparison result satisfies a predetermined condition.

In another embodiment, the foregoing apparatus may further include an initial loading module, an initial processing module, and metric reference determining module. The initial loading module may be configured to load, by the security chip, an initial trusted metric root to the host processor when the platform and the system are first started, where the initial trusted metric root is encrypted initial metric root. The initial processing module may be configured to receive, by the security chip, an initial processing result after the host processor performs asymmetric encryption and decryption processing on the initial trusted metric root. The processing result may include metric object data encrypted by a public key. The metric reference determining module may be configured to compute a Hash value of the initial metric object data, determine the Hash value as the metric reference value, and store the metric reference value in the security chip.

In embodiments, the metric object may include a plurality of metric objects, and the security chip may determine the integrity of each of the plurality of metric objects. In response to a determination that the integrity of each of the plurality of metric objects is in a normal state, the integrity of a platform and a system in which the security chip is implemented may be considered not compromised, and the system enters a safe mode.

In another embodiment, in response to a determination that the integrity of one or more of the plurality of metric objects is in an abnormal state, the integrity of the platform and the system in which the security chip is implemented may be determined to be compromised, and the system enters an unsafe mode, or the system is prohibited from booting.

The system may include one or more components that are similar to those illustrated in FIG. 1 and FIG. 6, and thus, are not described in detail herein.

### Embodiment 5

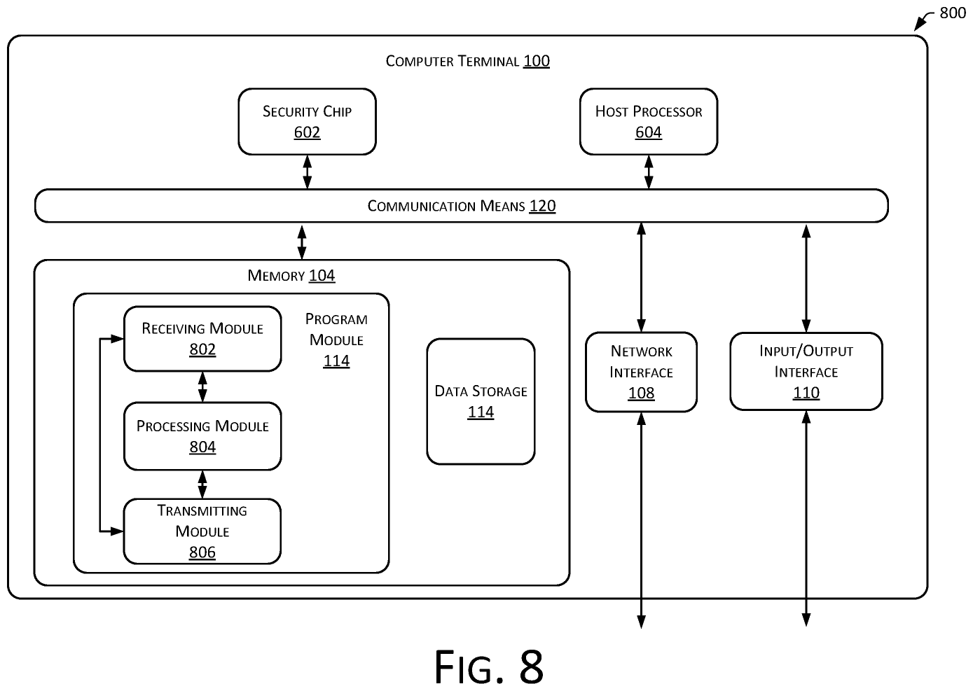

According to an embodiment of the present disclosure an apparatus to implement a method for activating measurement based on the trusted card described in Embodiment 2 is provided. FIG. 8 illustrates a schematic diagram of an apparatus for activating measurement based on a trusted card according to Embodiment 5 of the present disclosure.

The apparatus 800 may be implemented on a computer terminal 110, as illustrated in FIG. 1. The apparatus 800 may include a receiving module 802 configured to receive, by a host processor, a trusted metric root of a metric object loaded by a security chip, wherein the trusted metric root is an encrypted metric root.

The apparatus 800 may further include a processing module 804 configured to perform, by the host processor, asymmetric decryption processing on the trusted metric root to obtain a processing result, where the processing result includes metric object data encrypted by a public key.

The apparatus 800 may further include a transmitting module 806 configured to transmit, by the host processor, the processing result to the security chip to determine integrity of the metric object by performing a comparison on the decrypted metric object data to a metric reference value.

It should be noted here that the above receiving module 802, the processing module 804, and the transmitting module 806 may correspond to steps 502, 504, and 506, respectively, as described in Embodiment 2. The embodiments and application environment of the foregoing four modules and four steps may be the same but not limited to the content disclosed in the Embodiment 2. It should be noted that the above modules may be operated as part of an apparatus implemented in the computer terminal 100 provided in Embodiment 1 and Embodiment 3.

In another embodiment, the security chip may store the private key of the trusted root key pair, and the host processor may store the public key of the trusted root key pair.

The system may include one or more components that are similar to those illustrated in FIG. 1 and FIG. 6, and thus, are not described in detail herein.

### Embodiment 6

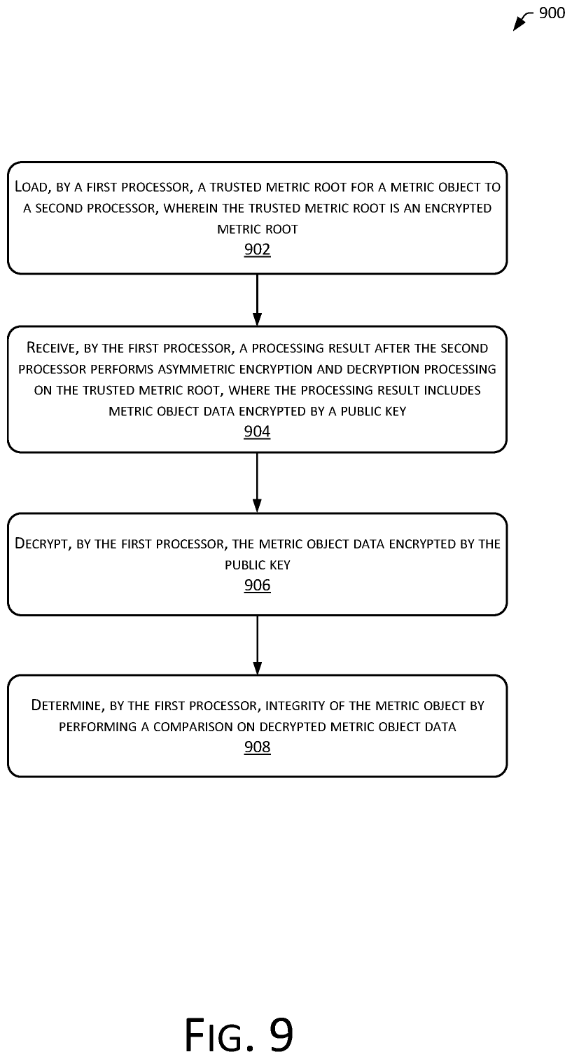

A data processing method is provided according to an embodiment of the present invention. FIG. 9 illustrates a flowchart of a data processing method according to Embodiment 6 of the present disclosure. The method may include steps as follows:

In step 902, a first processor loads a trusted metric root for a metric object to a second processor, wherein the trusted metric root is an encrypted metric root.

In embodiments, the first processor may be a security chip and the second processor may be a host processor. The metric object may be a BIOS (Basic Input Output System), an OS Loader (Operating System Loader), an OS (Operating System) kernel, or the like.

The metric root may be a reference value that is calculated during the first booting of the platform and the system. During the first booting, an initial metric value for the metric object may be calculated. A Hash operation may be further performed on the calculated initial metric value to obtain the metric root as the reference value. During the booting other than the first booting, an initial metric value may be calculated for the metric object and processed by a Hash operation. The Hash processed metric value may be further compared with the reference value to determine whether to start the platform and the system. The above noted second processor may be the system CPU.

The metric root may be stored in the above-described first processor. The first processor may encrypt the metric root by a private key in a preset asymmetric key pair to obtain a trusted metric root. The trusted metric root may be loaded into a memory of a main board, from where, the trusted metric root is further loaded to CPU.

In step 904, the first processor receives a processing result after the second processor performs asymmetric encryption and decryption processing on the trusted metric root, where the processing result includes metric object data encrypted by a public key.

In embodiments, the second processor may store the public key of the key pair, and the public key and the private key used to encrypt the metric root may form a pair of asymmetric keys.

In another embodiment, the second processor may perform asymmetric decryption processing on the trusted metric root to obtain a processing result. The second processor may perform decryption processing on the trusted metric root using the public key to obtain the metric root. The metric root may include metric code. Metric object data may be obtained by executing the metric code. The metric object data may be further encrypted using the public key to obtain the processing result.

The second processor may send the processing result to the first processor, and the first processor may then receive the processing result after the second processor performs asymmetric encryption and decryption processing on the trusted metric root.

In the above steps, the processing result sent by the second processor to the first processor may be the encrypted metric object data. Therefore, even if the metric object data is attacked during the transmitting from the second processor to the first processor, it is difficult for the attacker to obtain the metric object data and even more difficult to tamper with the metric object data.

In step 906, the first processor decrypts the metric object data encrypted by the public key.

In the above step 906, the first processor may decrypt the metric object data encrypted by the public key to obtain metric object data.

In one embodiment, the secure chip may use the private key (i.e., the private key used to encrypt the metric root) to decrypt the metric object data encrypted by the public key to obtain metric object data.

In step 908, the first processor determines integrity of the metric object by performing a comparison on decrypted metric object data.

In one embodiment, the comparison may be performed between a Hash value of the decrypted metric object data and a metric reference value. If the Hash value of the decrypted metric object data equals to the metric reference value, it may be determined that the metric object is in integrity. If the Hash value of the decrypted metric object data does not equal to the metric reference value, it may be determined that the metric object is not in integrity. It may be further determined that the platform and system may be under attack and compromised. When the system needs to start in trust, if it is determined that the metric object is in integrity, the system can be started; and if it is determined that the metric object is not in integrity, the system is prohibited from starting or enters an unsafe start mode.

In the above embodiments of the present disclosure, the first processor may load the trusted metric root of the metric object to the second processor, where the trusted metric root is the encrypted metric root. The first processor may receive from the second processor a processing result after the second processor performs asymmetric encryption and decryption processing on the trusted metric root, wherein the processing result includes metric object data encrypted by a public key. The first processor may decrypt the encrypted metric object data and determine integrity of the metric object by performing a comparison on the decrypted metric object data. Since the metric root loaded by the first processor to the second processor is the encrypted metric root, the security of the metric root can be guaranteed, and the metric root is prevented from being tampered. As the metric object data sent by the second processor to the first processor is also encrypted, thus ensuring the security of the metric object data, and further ensuring the accuracy of the metric code in the metric root and the execution result of the metric code.

Therefore, the foregoing embodiment of the present disclosure solves the technical problem of the measurement inaccuracy in determining the integrity of the platform and the system using the current trusted first processors.

### Embodiment 7

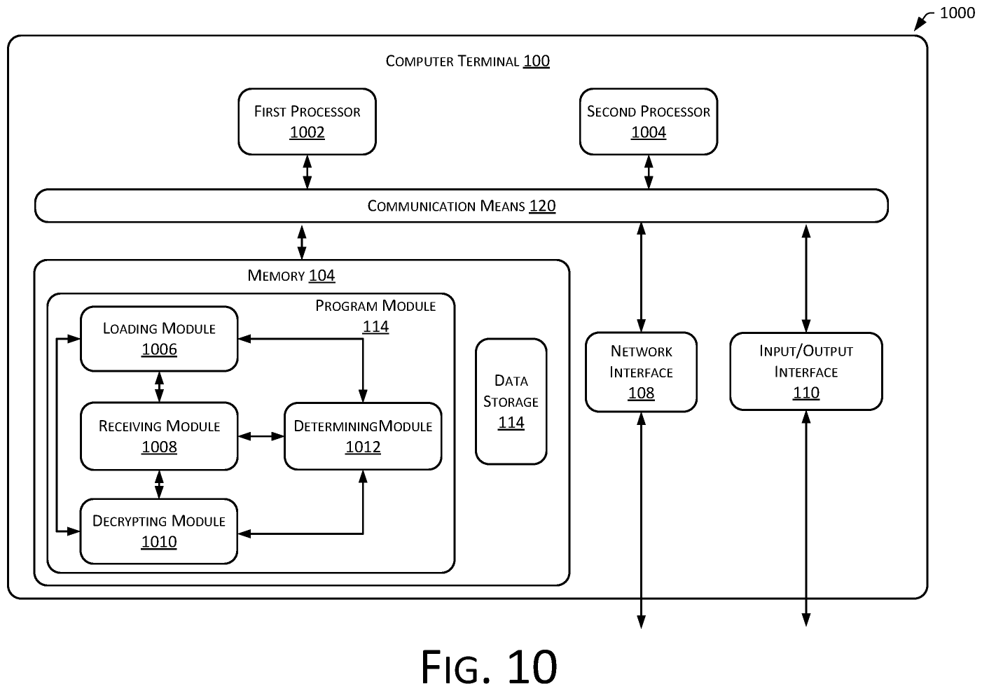

An apparatus to implement a data processing method according to Embodiment 6 is provided according to an embodiment of the present invention. FIG. 10 illustrates a schematic diagram of a data processing apparatus according to Embodiment 7 of the present disclosure.

The apparatus 1000 may be implemented on a computer terminal 110, as illustrated in FIG. 1. The apparatus 1000 may include a first processor 1002 and a second processor 1004. In embodiment, the first processor 1002 may be a security chip and the second processor may be a host processor.

The apparatus 1000 may further include a loading module 1006 configured to load, by the security chip, a trusted metric root to a host processor, where the entrusted metric root is encrypted metric root.

The apparatus 1000 may further include a receiving module 1008 configured to receive, by the security chip, a processing result after the host processor performs asymmetric encryption and decryption processing on the trusted metric root, where the processing result includes metric object data encrypted by a public key.

The apparatus 1000 may further include a decrypting module 1010 configured to decrypt, by the security chip, the metric object data encrypted by a public key.

The apparatus 1000 may further include a determining module 1012 configured to determine, by the security chip, integrity of the metric object by performing a comparison on the decrypted metric object data.

It should be noted here that the above loading module 1006, the receiving module 1008, the decrypting module 1010 and the determining module 1012 may correspond steps 902, 904, 906, and 908, respectively, as described in Embodiment 6. The embodiments and application environment of the foregoing four modules and four steps may be the same but not limited to the content disclosed in the Embodiment 6. It should be noted that the above modules may be operated as part of an apparatus implemented in the computer terminal 100 provided in Embodiment 1.

The system may include one or more components that are similar to those illustrated in FIG. 1, and thus, are not described in detail herein.

### Embodiment 8

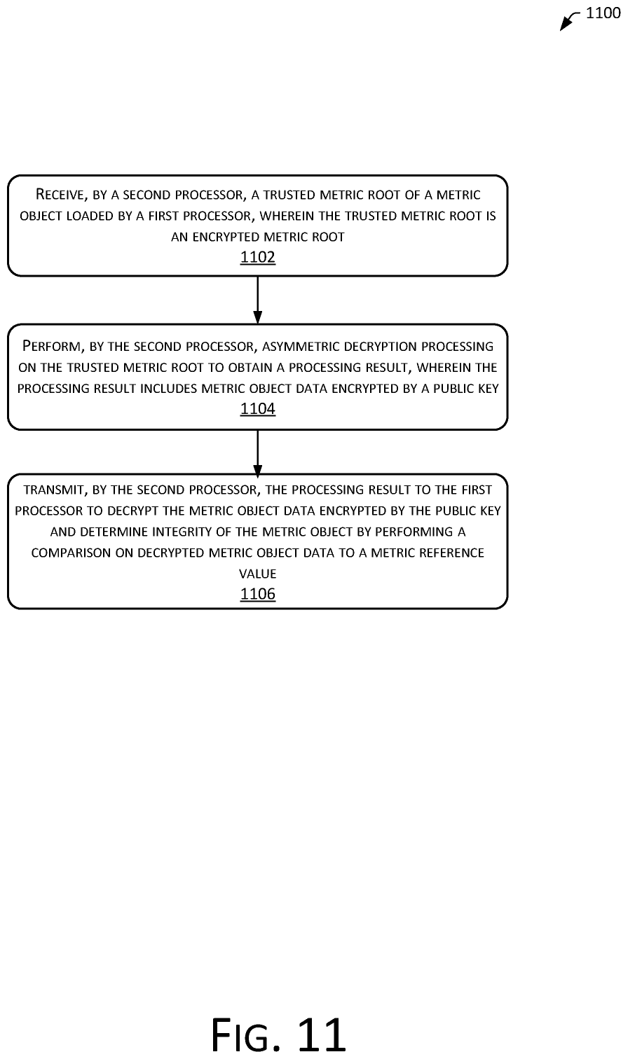

A data processing method is provided according to an embodiment of the present invention. FIG. 11 illustrates a flowchart of a data processing method according to Embodiment 8 of the present disclosure. The method may include steps as follows:

At step 1102, the second processor may receive a trusted metric root of a metric object loaded by a first processor, wherein the trusted metric root is an encrypted metric root.

Specifically, the first processor may be a security chip and the second processor may be a host processor. The above described encrypted metric root may include metric codes used to compute metric object data. The metric root may be encrypted by the first processor to obtain the trusted metric root, which may be further loaded to the first processor.

In another embodiment, the first processor may encrypt the metric root by using a private key to obtain a trusted metric root, and then load the trusted metric root into a memory space on the main board. The trusted metric root may be loaded from the memory space to the second processor.

Since the metric root loaded by the first processor to the second processor is the trusted metric root, i.e., the encrypted metric root, even if the second processor is attacked, the metric root cannot be obtained or tampered with, thereby ensuring the credibility of subsequent calculations.

At step 1104, the second processor may perform asymmetric decryption processing on the trusted metric root to obtain a processing result, where the processing result includes metric object data encrypted by a public key.

Specifically, the second processor may store the public key in a key pair, and the public key and the private key that encrypts the metric root may form a pair of asymmetric keys.

In another embodiment, the second processor may perform asymmetric encryption and decryption processing on the trusted metric root, and the second processor may decrypt the trusted metric root by using the public key to obtain a metric root. The metric root may include metric codes, and execution of the metric codes by the second processor may generate the metric object data of the metric object. The second processor may use the public key to encrypt the metric object data to obtain the processing result.

At step 1106, the second processor may transmit the processing result to the first processor to encrypt the metric object data encrypted by the public key and determine integrity of the metric object by performing a comparison on the decrypted metric object data to a metric reference value.

The second processor may send the obtained processing result to the first processor, and the first processor may receive the processing result after the second processor performs asymmetric encryption and decryption processing on the trusted metric root. The first processor may decrypt the processing result using the private key to obtain the metric object data.

The first processor may compute a Hash value of the metric object data and compare the Hash value with a stored metric reference value to determine integrity of the metric object.

In the above steps, the processing result sent by the second processor to the first processor may be encrypted metric object data, so that even if the metric object data is attacked during the transmission from the second processor to the first processor, it is difficult for the attacker to obtain the metric object data and even more difficult to tamper with the metric object data.

The second processor of the foregoing embodiment of the present disclosure may receive the trusted metric root of the metric object loaded by the first processor, where the trusted metric root may be an encrypted metric root. The second processor may perform asymmetric encryption and decryption processing on the trusted metric root to obtain a processing result, where the processing result may comprise a metric object data encrypted by a public key. The second processor may transmit the processing result to the first processor, where the first processor may decrypt the metric object data and perform a comparison on the decrypted metric object data to determine integrity of the metric object. Since the metric root loaded by the first processor to the second processor is an encrypted metric root, the security of the metric root can be guaranteed. The metric root may be prevented from being tampered with by the attack during the transmission of the metric object data from the second processor to the first processor. The encryption process can ensure the security of the metric object data, thereby ensuring the metric code in the metric root and the accuracy of the result by executing the metric code. Thus, the present disclosure solves the technical problem of the measurement inaccuracy in determining the integrity of the platform and the system using the current trusted first processors.

### Embodiment 9

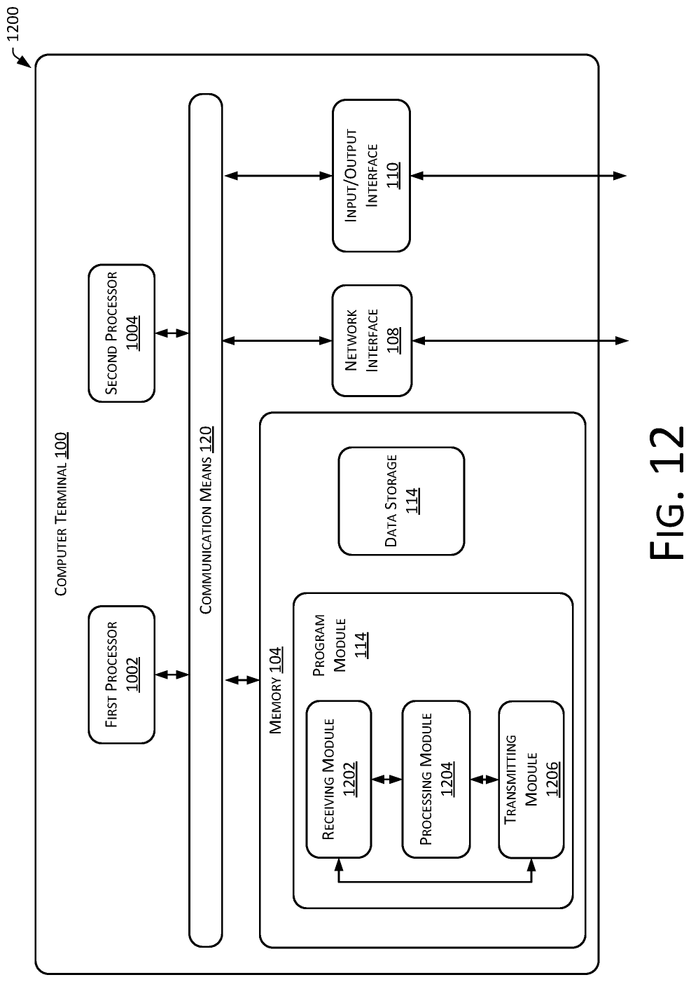

An apparatus to implement a data processing method according to Embodiment 8 is provided according to an embodiment of the present invention. FIG. 12 illustrates a schematic diagram of a data processing apparatus according to according to Embodiment 9 of the present disclosure.

The apparatus 1200 may be implemented on a computer terminal 110, as illustrated in FIG. 1 or FIG. 10. The apparatus 1200 may include a first processor 1002 and a second processor 1004, similar to those illustrated in FIG. 10. In embodiment, the first processor 1002 may be a security chip and the second processor may be a host processor.

The apparatus 1200 may further include a receiving module 1202 configured to receive, by a second processor, a trusted metric root of a metric object loaded by a first processor, wherein the trusted metric root is an encrypted metric root.

The apparatus 1200 may further include a processing module 1204 configured to perform, by the second processor, asymmetric decryption processing on the trusted metric root to obtain a processing result, where the processing result includes metric object data encrypted by a public key.

The apparatus 1200 may further include a transmitting module 1206 configured to transmit, by the second processor, the processing result to the first processor to decrypt the metric object data encrypted by the public key and determine integrity of the metric object by performing a comparison on the decrypted metric object data to a metric reference value.

It should be noted here that the above receiving module 1202, the processing module 1204, and the transmitting module 1206 may correspond to steps 1102, 1104, and 1106, respectively, as described in Embodiment 8. The embodiments and application environment of the foregoing four modules and four steps may be the same but not limited to the content disclosed in the Embodiment 8. It should be noted that the above modules may be operated as part of an apparatus implemented in the computer terminal 100 provided in Embodiment 1 and Embodiment 7.

### Embodiment 10

Embodiments of the present disclosure may provide a computer terminal, which may be any one of computer terminal groups. In embodiments, the foregoing computer terminal may also be replaced with a terminal device such as a mobile terminal.

In one embodiment, the computer terminal may be located in at least one network device of the plurality of network devices of the computer network.

In the present embodiment, the above computer terminal may execute program codes to perform the method of activating measurement based on a trusted card including: loading, by a security chip, a trusted metric root for a metric object to a host processor, wherein the trusted metric root is an encrypted metric root, receiving, by the security chip, a processing result after the host processor performs asymmetric encryption and decryption processing on the trusted metric root, where the processing result includes metric object data encrypted by a public key, decrypting, by the security chip, the encrypted metric object data, and determining, by the security chip, integrity of the metric object by performing a comparison on the decrypted metric object data.

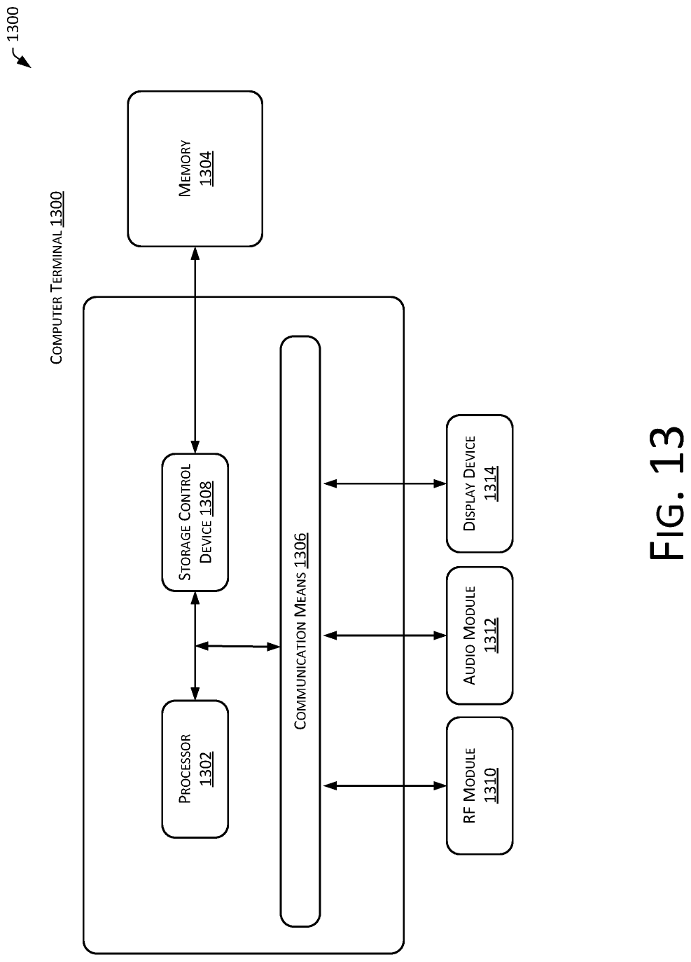

FIG. 13 illustrates a structural block diagram of a computer terminal according to Embodiment 10 of the present disclosure. As illustrated in FIG. 13, the computer terminal 1300 may include one or more processors 1302 (one processor 1302 is shown in the FIG. 13), memory 1304, communication means 1306, a storage control device 1308, an RF module 1310, an audio module 1312, and a display device 1314.

The memory 1304 may be used to store software programs and program modules, for example, program instructions/data storage apparatus that correspond to a method of activating measurement based on a trusted card. The one or more processors may perform functional applications and data processing by executing the software programs and the corresponding program modules stored in the memory, thus implementing the above-noted method of activating measurement based on a trusted card. The memory 1304 may include high-speed random-access memory, non-volatile memory, such as one or more magnetic storage devices, flash memory, or other non-volatile solid-state memory. The memory 1304 may be non-transitory. In some examples, the memory 1304 may further comprise a remote memory configured for the one or more processors. Such remote memory may be connected to the computer terminal 1300 via a network. Examples of such networks may include but not limited to the Internet, intranets, local area networks, mobile communication networks, and any combinations thereof.

The processor 1302 may call the information and application programs stored in the memory 1304 through the communication means 1306 to execute the steps including loading, by a security chip, a trusted metric root for a metric object to a host processor, wherein the trusted metric root is an encrypted metric root, receiving, by the security chip, a processing result after the host processor performs asymmetric encryption and decryption processing on the trusted metric root, wherein the processing result includes metric object data encrypted by a public key, decrypting, by the security chip, the metric object data encrypted by the public key, and determining, by the security chip, integrity of the metric object by performing a comparison on the decrypted metric object data.

In embodiments, the processor 1302 may execute program codes to further perform steps including pre-storing a private key for the encrypted trusted metric root in the security chip pre-storing the public key for the encrypted trusted metric root in the host processor.

In embodiments, the processor 1302 may execute program codes to further perform steps including powering on the security chip, loading, by the security chip, a metric root of the metric object to the encryption module of the security chip, and encrypting the metric root, by the encryption module, using the private key to obtain the trusted metric root.

In embodiments, the processor 1302 may execute program codes to further perform steps including after the security chip loads the trusted metric root to the host processor, decrypting, by the host processor, the trusted metric root using the public key to obtain a decrypted trusted metric root, executing, by the host processor, the decrypted trusted metric root to obtain the metric object data, encrypting, by the host processor, the metric object data using the public key, and sending, by the host processor, the encrypted metric object data to the security chip.

In embodiments, the processor 1302 may execute program codes to further perform steps including calling, by the security chip, a decryption module, and decrypting, by the decryption module, the metric object data encrypted by the public key by using the private key to obtain the decrypted metric object data.

In embodiments, the processor 1302 may execute program codes to further perform steps including calculating, by the security chip, a Hash value of the metric object data, comparing the calculated Hash value with a metric reference value, and determining that the integrity of the metric object is in a normal state in response to a comparison result satisfying a predetermined condition.

In embodiments, the processor 1302 may execute program codes to further perform steps including before the security chip loads the trusted metric root to the host processor, upon first booting, loading, by the security chip, an initial trusted metric root of the metric object to the host processor, wherein the initial trusted metric root is an encrypted initial metric root, receiving, by the security chip, an initial processing result after the host processor performs asymmetric encryption and decryption processing on the initial trusted metric root, where the initial processing result includes initial metric object data encrypted by the public key, calculating, by the security chip, an initial hash value of the initial metric object data; determining, by the security chip, the initial hash as the metric reference value, and storing the metric reference value to the security chip.

In embodiments, the processor 1302 may execute program codes to further perform steps including when the metric object includes a plurality of metric objects, determining, by the security chip, integrity of each of the plurality of metric objects, determining, by the security chip, whether the integrity of each of the plurality of metric objects is in a normal state, and in response to a determination that the integrity of each of the plurality of metric objects is in a normal state, determining that integrity of a platform and a system in which the security chip is implemented is not compromised, and the system enters a safe mode.

In embodiments, the processor 1302 may execute program codes to further perform steps including in response to a determination that the integrity of one or more of the plurality of metric objects is in an abnormal state, determining that the integrity of the platform and the system in which the security chip is implemented is compromised, and the system enters an unsafe mode, or the system is prohibited from booting.

In the above embodiments of the present disclosure, the security chip may load the trusted metric root of the metric object to the host processor, where the trusted metric root is the encrypted metric root. The security chip may receive from the host processor a processing result after the host processor performs asymmetric encryption and decryption processing on the trusted metric root, where the processing result includes metric object data encrypted by a public key. The security chip may decrypt the encrypted metric object data and determine integrity of the metric object by performing a comparison on the decrypted metric object data. Since the metric root loaded by the security chip to the host processor is the encrypted metric root, the security of the metric root can be guaranteed, and the metric root is prevented from being tampered. As the metric object data sent by the host processor to the security chip is also encrypted, the security of the metric object data is ensured, and the accuracy of the metric code in the metric root and the execution result of the metric code are further ensured. Therefore, the foregoing embodiment of the present disclosure solves the technical problem of the measurement inaccuracy in determining the integrity of the platform and the system using the current trusted first processors.

It should be understood by a person skilled in the art that the structural diagram shown in FIG. 13 is merely for illustration, and the computer terminal can also be a smart phone (such as an Android mobile phone, an iOS mobile phone, etc.), a tablet computer, a palm computer, and a mobile Internet device (Mobile Internet Devices, MID), PAD and other terminal devices. FIG. 13 does not limit the structure of the above electronic devices. For example, a computer terminal 1300 may further include more or less components than those shown in FIG. 13 (e.g., a network interface, a display device, etc.). In embodiment, the components of the computer terminal 1300 may have different configurations from those described in connection with FIG. 13.

It should be further understood by a person of ordinary skill in the art that all or part of the steps of the foregoing embodiments may be performed by a program to instruct related hardware of a terminal device, the program may be stored in a computer readable storage medium, and the storage medium may comprise a flash disk, read-only memories (the Read-Only memory, a ROM), a random access (the random access memory, the RAM), magnetic disk, or optical disk. The computer readable storage medium may be non-transitory.

### Embodiment 11

Embodiments of the present invention also provide a storage medium. In the present embodiment, the storage medium may be provided for storing the program codes, which when executed, causing the implementation of a method to activate measurement based on a trusted card. The storage medium may be non-transitory storage medium.

In embodiment, the foregoing storage medium may be located in any one of the computer terminal groups in the computer network, or in any one of the mobile terminal groups.

In another embodiment, the storage medium may be configured to store program codes for performing the steps including loading, by a security chip, a trusted metric root for a metric object to a host processor, wherein the trusted metric root is an encrypted metric root, receiving, by the security chip, a processing result after the host processor performs asymmetric encryption and decryption processing on the trusted metric root, where the processing result includes metric object data encrypted by a public key, decrypting, by the security chip, the encrypted metric object data, and determining, by the security chip, integrity of the metric object by performing a comparison on the decrypted metric object data.

The serial numbers of the embodiments of the present disclosure are merely for illustration, and do not represent the advantages or disadvantages of the embodiments.

In the above-mentioned embodiments of the present disclosure, the descriptions of the various embodiments are different, and the parts that are not detailed in a certain embodiment can be referred to the related descriptions of other embodiments.

In one or more embodiments provided by the present disclosure, it should be understood that the disclosed technical contents may be implemented in other manners. The apparatus embodiments described above are merely illustrative. For example, the division of the modules is merely a logical function division. In actual implementation, there may be another division manner. For example, multiple modules, sub-modules, or components may be combined or integrated into another system, or some features may be ignored or not executed. In addition, the mutual coupling, direct coupling or communication connection shown or discussed may be an indirect coupling or communication connection through some interface, module or sub-module, and may be an electrical connection or otherwise.

The modules described as separate components may or may not be physically separated, and the components displayed as modules may or may not be physical modules. That is, the components may be located in one place, or may be distributed to multiple network places. Some or all of the modules may be selected according to actual needs to achieve the purpose of the solution of the embodiment.

In addition, each functional module in each embodiment of the present disclosure may be integrated into one processing module, or each module may exist separated physically, or two or more modules may be integrated into one module. The above integrated module can be implemented in the form of hardware or in the form of a software functional module.

The integrated module, if implemented in the form of a software functional module and sold or used as a standalone product, may be stored in a computer readable storage medium. Based on such understanding, the technical solution of the present disclosure, which is essential or contributes to the prior art, or all or part of the technical solution, may be embodied in the form of a software product stored in a storage medium. A number of instructions are included to cause a computer device (which may be a personal computer, server or network device, etc.) to perform all or part of the steps of the methods described in various embodiments of the present disclosure. The storage medium may include the U-disk, read only memory (a ROM, the Read-Only Memory), a random-access memory (the RAM, the Random-Access Memory), removable hard disk, magnetic disk, or any medium may store program code, optical disc. The storage medium may be non-transitory.

The above description is only a preferred embodiment of the present disclosure, and it should be noted that those skilled in the art can also make several improvements and revisions without departing from the principles of the present disclosure. Those improvements and revisions should be considered as the scope of protection of the present disclosure.

The present disclosure can further be understood using the following clauses.

Clause 1: A method comprising: loading, by a security chip, a trusted metric root for a metric object to a host processor, wherein the trusted metric root is an encrypted metric root; receiving, by the security chip, a processing result after the host processor performs asymmetric encryption and decryption processing on the trusted metric root, wherein the processing result includes metric object data encrypted by a public key; decrypting, by the security chip, the metric object data encrypted by the public key; and determining, by the security chip, integrity of the metric object by performing a comparison on decrypted metric object data.

Clause 2: The method according to Clause 1, wherein the security chip stores a private key for the trusted metric root, and the host processor stores the public key for the trusted metric root.

Clause 3: The method according to Clause 2, wherein before the security chip loads the trusted metric root of the metric object to the host processor, the method further comprises: loading, by the security chip, a metric root of the metric object to an encryption module; and encrypting the metric root, by the encryption module, using the private key to obtain the trusted metric root.

Clause 4: The method according to Clause 2, wherein decrypting, by the security chip, the metric object data encrypted by the public key comprises: calling, by the security chip, a decryption module; and decrypting, by the decryption module, the encrypted metric object data encrypted by the public key using the private key to obtain the decrypted metric object data.

Clause 5: The method according to Clause 1, wherein determining, by the security chip, integrity of the metric object by performing a comparison on decrypted metric object data comprises: calculating, by the security chip, a Hash value of the metric object data; comparing the calculated Hash value with a metric reference value; and determining that the integrity of the metric object is in a normal state in response to a comparison result satisfying a predetermined condition.

Clause 6: The method according to Clause 5, wherein before loading a trusted metric root for a metric object to a host processor, the method further comprises: upon first booting, loading, by the security chip, an initial trusted metric root of the metric object to the host processor, wherein the initial trusted metric root is an encrypted initial metric root; receiving, by the security chip, an initial processing result after the host processor performs asymmetric encryption and decryption processing on the initial trusted metric root, where the initial processing result includes initial metric object data encrypted by the public key; calculating, by the security chip, an initial Hash value of the initial metric object data; determining, by the security chip, the initial Hash as the metric reference value; and storing the metric reference value at the security chip.

Clause 7: The method according to Clause 1, wherein the metric object includes a plurality of metric objects, and the method further comprises: determining, by the security chip, integrity of each of the plurality of metric objects; determining, by the security chip, whether the integrity of each of the plurality of metric objects is in a normal state; and in response to a determination that the integrity of each of the plurality of metric objects is in a normal state, determining that integrity of a platform and a system in which the security chip is implemented is not compromised, and the system enters a safe mode.

Clause 8: The method according to Clause 7, further comprising: in response to a determination that the integrity of one or more of the plurality of metric objects is in an abnormal state, determining that the integrity of the platform and the system in which the security chip is implemented is compromised, and the system enters an unsafe mode, or the system is prohibited from booting.

Clause 9: A method comprising: receiving, by a host processor, a trusted metric root of a metric object loaded by a security chip, wherein the trusted metric root is an encrypted metric root; performing, by the host processor, asymmetric decryption processing on the trusted metric root to obtain a processing result, wherein the processing result includes metric object data encrypted by a public key; and transmitting, by the host processor, the processing result to the security chip to decrypt the metric object data encrypted by a public key and determine integrity of the metric object by comparing decrypted metric object data to a metric reference value.

Clause 10: The method according to Clause 9, wherein the security chip stores a private key for the trusted metric root, and the host processor stores the public key for the trusted metric root.

Clause 11: The method according to Clause 10, wherein performing, by the host processor, asymmetric decryption processing on the trusted metric root to obtain a processing result further comprises: decrypting, by the host processor, the trusted metric root using the public key to obtain a decrypted trusted metric root; executing, by the host processor, the decrypted trusted metric root to obtain the metric object data; encrypting, by the host processor, the metric object data using the public key; and sending, by the host processor, encrypted metric object data to the security chip.

Clause 12: A system comprising: a security chip configured to store a trusted metric root of a metric object, wherein the trusted metric root is an encrypted metric root; and a host processor configured to receive the trusted metric root of the metric object loaded by the security chip; and perform an asymmetric encryption and decryption process on the trusted metric root to obtain a processing result, wherein the processing result includes metric object data encrypted by a public key, wherein the security chip is further configured to decrypt the metric object data encrypted using the public key; and determine integrity of the metric object by performing a comparison on decrypted metric object data.

Clause 13: The system according to Clause 12, wherein the security chip stores a private key for the trusted metric root, and the host processor stores the public key for the trusted metric root.

Clause 14: The system according to Clause 12, wherein before the trusted metric root of the metric object is loaded to the host processor, the security chip is further configured to: load a metric root of the metric object to an encryption module; and encrypt, by the encryption module, using the private key to obtain the trusted metric root.

Clause 15: The system according to Clause 12, wherein to decrypt encrypted metric object data, the security chip is further configured to: call a decryption module of the security chip; and decrypt, by the decryption module, the metric object data encrypted by the public key using the private key to obtain the decrypted metric object data.

Clause 16: The system according to Clause 12, wherein to determine integrity of the metric object by performing a comparison on decrypted metric object data, the security chip is further configured to: calculate a Hash value of the metric object data; compare the calculated Hash value with a metric reference value; and determine that the integrity of the metric object is in a normal state in response to a comparison result satisfying a predetermined condition.

Clause 17: The system according to Clause 16, wherein before loading a trusted metric root for a metric object to a host processor, the security chip is further configured to: upon first booting, loading an initial trusted metric root of the metric object to the host processor, wherein the initial trusted metric root is an encrypted initial metric root; receiving an initial processing result after the host processor performs asymmetric encryption and decryption processing on the initial trusted metric root, where the initial processing result includes initial metric object data encrypted by the public key; calculating an initial Hash value of the initial metric object data; determining the initial Hash as the metric reference value; and store the metric reference value at the security chip.

Clause 18: The system according to Clause 12, wherein the metric object includes a plurality of metric objects, and the security chip is further configured to: determine integrity of each of the plurality of metric objects; determine whether the integrity of each of the plurality of metric objects is in a normal state; in response to a determination that the integrity of each of the plurality of metric objects is in a normal state, determine that integrity of a platform and a system in which the security chip is implemented is not compromised, and the system enters a safe mode; and in response to a determination that the integrity of one or more of the plurality of metric objects is in an abnormal state, determine that the integrity of the platform and the system in which the security chip is implemented is compromised, and the system enters an unsafe mode, or the system is prohibited from booting.

Clause 19: The system according to Clause 12, wherein to perform asymmetric decryption processing on the trusted metric root to obtain a processing result, the host processor is further configured to: decrypt the trusted metric root using the public key to obtain a decrypted trusted metric root; execute the decrypted trusted metric root to obtain the metric object data; encrypt the metric object data using the public key; and send encrypted metric object data to the security chip.

Clause 20: A computer-readable storage medium storing computer-readable instructions executable by one or more processors, that when executed by the one or more processors, cause the one or more processors to perform operations comprising: loading, by a security chip, a trusted metric root for a metric object to the host processor, wherein the trusted metric root is an encrypted metric root; receiving, by the security chip, a processing result after the host processor performs asymmetric encryption and decryption processing on the trusted metric root, wherein the processing result includes metric object data encrypted by a public key; decrypting, by the security chip, the metric object data encrypted by the public key; and determining, by the security chip, integrity of the metric object by performing a comparison on decrypted metric object data.

What is claimed is:

1. A method comprising:
loading, by a security chip, a trusted metric root for a metric object to a host processor, wherein the trusted metric root is an encrypted metric root;
receiving, by the security chip, a processing result after the host processor performs asymmetric encryption and decryption processing on the trusted metric root, wherein the processing result includes metric object data encrypted by a public key;
decrypting, by the security chip, the metric object data encrypted by the public key; and
determining, by the security chip, integrity of the metric object by performing a comparison on decrypted metric object data.

2. The method according to claim 1, wherein the security chip stores a private key for the trusted metric root, and the host processor stores the public key for the trusted metric root.

3. The method according to claim 2, wherein before the security chip loads the trusted metric root of the metric object to the host processor, the method further comprises:
loading, by the security chip, a metric root of the metric object to an encryption module; and
encrypting the metric root, by the encryption module, using the private key to obtain the trusted metric root.

4. The method according to claim 2, wherein decrypting, by the security chip, the metric object data encrypted by the public key comprises:
calling, by the security chip, a decryption module; and
decrypting, by the decryption module, the encrypted metric object data encrypted by the public key using the private key to obtain the decrypted metric object data.

5. The method according to claim 1, wherein determining, by the security chip, integrity of the metric object by performing a comparison on decrypted metric object data comprises:
calculating, by the security chip, a Hash value of the metric object data;
comparing the calculated Hash value with a metric reference value; and
determining that the integrity of the metric object is in a normal state in response to a comparison result satisfying a predetermined condition.

6. The method according to claim 5, wherein before loading a trusted metric root for a metric object to a host processor, the method further comprises:
upon first booting, loading, by the security chip, an initial trusted metric root of the metric object to the host processor, wherein the initial trusted metric root is an encrypted initial metric root;
receiving, by the security chip, an initial processing result after the host processor performs asymmetric encryption and decryption processing on the initial trusted metric root, where the initial processing result includes initial metric object data encrypted by the public key;
calculating, by the security chip, an initial Hash value of the initial metric object data;
determining, by the security chip, the initial Hash as the metric reference value; and
storing the metric reference value at the security chip.

7. The method according to claim 1, wherein the metric object includes a plurality of metric objects, and the method further comprises:
determining, by the security chip, integrity of each of the plurality of metric objects;
determining, by the security chip, whether the integrity of each of the plurality of metric objects is in a normal state; and
in response to a determination that the integrity of each of the plurality of metric objects is in a normal state, determining that integrity of a platform and a system in which the security chip is implemented is not compromised, and the system enters a safe mode.

8. The method according to claim 7, further comprising:
in response to a determination that the integrity of one or more of the plurality of metric objects is in an abnormal state, determining that the integrity of the platform and the system in which the security chip is implemented is compromised, and the system enters an unsafe mode, or the system is prohibited from booting.

9. A method comprising:
receiving, by a host processor, a trusted metric root of a metric object loaded by a security chip, wherein the trusted metric root is an encrypted metric root;
performing, by the host processor, asymmetric decryption processing on the trusted metric root to obtain a processing result, wherein the processing result includes metric object data encrypted by a public key; and
transmitting, by the host processor, the processing result to the security chip to decrypt the metric object data encrypted by a public key and determine integrity of the metric object by comparing decrypted metric object data to a metric reference value.

10. The method according to claim 9, wherein the security chip stores a private key for the trusted metric root, and the host processor stores the public key for the trusted metric root.

11. The method according to claim 10, wherein performing, by the host processor, asymmetric decryption processing on the trusted metric root to obtain a processing result further comprises:
decrypting, by the host processor, the trusted metric root using the public key to obtain a decrypted trusted metric root;
executing, by the host processor, the decrypted trusted metric root to obtain the metric object data;
encrypting, by the host processor, the metric object data using the public key; and
sending, by the host processor, encrypted metric object data to the security chip.

12. A system comprising:
a security chip configured to store a trusted metric root of a metric object, wherein the trusted metric root is an encrypted metric root; and
a host processor configured to
receive the trusted metric root of the metric object loaded by the security chip; and
perform an asymmetric encryption and decryption process on the trusted metric root to obtain a processing result, wherein the processing result includes metric object data encrypted by a public key,
wherein the security chip is further configured to
decrypt the metric object data encrypted using the public key; and
determine integrity of the metric object by performing a comparison on decrypted metric object data.

13. The system according to claim 12, wherein the security chip stores a private key for the trusted metric root, and the host processor stores the public key for the trusted metric root.

14. The system according to claim 12, wherein before the trusted metric root of the metric object is loaded to the host processor, the security chip is further configured to:
load a metric root of the metric object to an encryption module; and
encrypt, by the encryption module, using the private key to obtain the trusted metric root.

15. The system according to claim 12, wherein to decrypt encrypted metric object data, the security chip is further configured to:
call a decryption module of the security chip; and
decrypt, by the decryption module, the metric object data encrypted by the public key using the private key to obtain the decrypted metric object data.

16. The system according to claim 12, wherein to determine integrity of the metric object by performing a comparison on decrypted metric object data, the security chip is further configured to:
calculate a Hash value of the metric object data;
compare the calculated Hash value with a metric reference value; and
determine that the integrity of the metric object is in a normal state in response to a comparison result satisfying a predetermined condition.

17. The system according to claim 16, wherein before loading a trusted metric root for a metric object to a host processor, the security chip is further configured to:
upon first booting, loading an initial trusted metric root of the metric object to the host processor, wherein the initial trusted metric root is an encrypted initial metric root;
receiving an initial processing result after the host processor performs asymmetric encryption and decryption processing on the initial trusted metric root, where the initial processing result includes initial metric object data encrypted by the public key;
calculating an initial Hash value of the initial metric object data;
determining the initial Hash as the metric reference value; and
store the metric reference value at the security chip.

18. The system according to claim 12, wherein the metric object includes a plurality of metric objects, and the security chip is further configured to:
determine integrity of each of the plurality of metric objects;
determine whether the integrity of each of the plurality of metric objects is in a normal state;
in response to a determination that the integrity of each of the plurality of metric objects is in a normal state, determine that integrity of a platform and a system in which the security chip is implemented is not compromised, and the system enters a safe mode; and
in response to a determination that the integrity of one or more of the plurality of metric objects is in an abnormal state, determine that the integrity of the platform and the system in which the security chip is implemented is compromised, and the system enters an unsafe mode, or the system is prohibited from booting.

19. The system according to claim 12, wherein to perform asymmetric decryption processing on the trusted metric root to obtain a processing result, the host processor is further configured to:
decrypt the trusted metric root using the public key to obtain a decrypted trusted metric root;
execute the decrypted trusted metric root to obtain the metric object data;
encrypt the metric object data using the public key; and
send encrypted metric object data to the security chip.

20. A computer-readable storage medium storing computer-readable instructions executable by one or more processors, that when executed by the one or more processors, cause the one or more processors to perform operations comprising:
loading, by a security chip, a trusted metric root for a metric object to the host processor, wherein the trusted metric root is an encrypted metric root;
receiving, by the security chip, a processing result after the host processor performs asymmetric encryption and decryption processing on the trusted metric root, wherein the processing result includes metric object data encrypted by a public key;
decrypting, by the security chip, the metric object data encrypted by the public key; and
determining, by the security chip, integrity of the metric object by performing a comparison on decrypted metric object data.
